(19) United States
(12) Patent Application Publication
(10) Pub. No.: US 2026/0176115 A1
(43) Pub. Date: Jun. 25, 2026

(54) TOOLBOX FOR AN INDUSTRIAL TRUCK

(71) Applicant: Liftow Limited, Mississauga (CA)

(72) Inventor: David Gary Cormack, Glen Williams (CA)

(21) Appl. No.: 18/999,893

(22) Filed: Dec. 23, 2024

(51) Int. Cl. B66F 9/075; B25H 5/00

(52) U.S. Cl. CPC B66F 9/07504; B25H 5/00

(57) ABSTRACT

A toolbox for an industrial truck is disclosed. The industrial truck is provided in a form of a Class I industrial truck, a Class IV industrial truck, or a Class V industrial truck and includes an operator cab defined by an overhead guard. The operator cab includes a hood covering a power module, an operator seat disposed on the hood, and a toolbox. The toolbox has an outer lid with an outer lid latch, one or more hinges, a first compartment, a second compartment, and a bottom plate. The bottom plate is coupled to the top of the hood adjacent to a first side of the operator seat.

### BRIEF SUMMARY

This disclosure generally relates to a toolbox for use with industrial trucks, such as Class 1, IV, and V industrial trucks, also known as counterbalanced forklifts, both electric or internal combustion (IC) engine powered. More specially, this disclosure relates to a toolbox that is mounted on the forklift hood and designed to carry tools and keep them secure while the hood is lifted for inspection and/or maintenance.

### BACKGROUND

Forklifts and other industrial trucks are commonly used within warehouses, logistics centers, and manufacturing facilities for operational support. Existing forklift designs lack adequate onboard storage means for tools used by operators or other users during routine maintenance or other servicing tasks. Traditionally, operators rely on external tool storage means or other arrangements within the forklift or industrial truck. Current designs can lead to inefficiencies, safety hazards, and potential damage or loss of tools. Thus, there exists a need for an improved toolbox for use with forklifts and other industrial trucks.

### SUMMARY

This disclosure generally relates to a toolbox for use with forklifts and other industrial trucks. More specifically, the disclosure relates to a toolbox capable of being interchangeably installed on various industrial trucks.

In one aspect, an industrial truck provided in a form of a Class I industrial truck, a Class IV industrial truck, or a Class V industrial truck is provided. The industrial truck includes an operator cab defined by an overhead guard. The operator cab includes a hood covering a power module, an operator seat having a bottom coupled to a top of the hood, and a toolbox. The toolbox includes an outer lid with a lid latch, one or more hinges, a first compartment, a second compartment, and a bottom plate. The bottom plate is coupled to the top of the hood adjacent a first side of the operator seat.

In some instances, the toolbox is coupled to the top of the hood using one or more couplings removably attached to an outer surface of the bottom plate of the second compartment. In some embodiments, the toolbox stays affixed to the hood when the hood is opened for access to the power module. In some aspects, the toolbox is positioned such that the toolbox fits between the operator seat and a rear portion of the overhead guard when the hood is opened for access to the power module. In some embodiments, the power module is provided in the form of a traction battery. In some forms, the power module is provided in the form of an engine connected to a fuel source. In some embodiments, a clip is disposed on a top surface of the outer lid of the toolbox for coupling items to the outer lid. In some instances, the toolbox includes a clip disposed on the top surface of the outer lid for coupling items to the outer lid. In some aspects, the toolbox is positioned so that the top surface of the outer lid of the toolbox is approximately elbow height for an operator seated in the operator seat, such that the top surface of the outer lid is a writing surface. In some forms, the first side of the operator seat is a right side of the operator seat when an operator is seated in the operator seat. In some embodiments, the outer lid of the toolbox is located above the first compartment and the second compartment and the first compartment is located in between the outer lid and the second compartment when in a first position. In some aspects, the first compartment includes an aperture for a charging cord and the first compartment is configured to securely transport a cell phone. In some forms, the second compartment is configured to securely transport tools and other supplies. In some instances, the outer lid of the toolbox is opened in a direction that is away from the operator seat, such that the lid latch is facing the operator seat and the one or more hinges are opposite the lid latch and facing an exterior of the industrial truck.

In another aspect, an industrial truck provided in a form of a Class I industrial truck, a Class IV industrial truck, or a Class V industrial truck is provided. The industrial truck includes an operator cab defined by an overhead guard with a right rear overhead guard and a left rear overhead guard. The operator cab includes a hood covering a power module, an operator seat having a bottom coupled to a top of the hood, and a toolbox. The toolbox includes an outer lid with a lid latch. The lid latch is on a first side of the toolbox and is positioned facing a right side of the operator seat. The toolbox also includes one or more hinges designed to allow the toolbox to open away from the operator seat, such that the one or more hinges are on a second side of the toolbox positioned facing opposite the lid latch. The toolbox further includes a first compartment positioned below the outer lid, a second compartment positioned below the first compartment, and a bottom plate coupled to the top of the hood adjacent to the right side of the operator seat.

In some embodiments, the toolbox is coupled to the top of the hood using one or more couplings removably attached to an outer surface of the bottom plate of the second compartment. In other aspects, the toolbox stays affixed to the hood when the hood is opened for access to the power module. In some forms, the toolbox is positioned such that the toolbox fits between the operator seat and the right rear overhead guard when the hood is opened for access to the power module. In some instances, the first compartment includes an aperture for a charging cord and the first compartment is configured to securely transport a cell phone. In some aspects, the second compartment is configured to securely transport tools and other supplies. In some instances, a clip is disposed on a top surface of the outer lid of the toolbox for coupling items to the outer lid

### BRIEF DESCRIPTION OF DRAWINGS

FIG. 1 is a left side elevational view of a first embodiment of an industrial truck with a toolbox positioned in a first configuration and a hood of a power module shown in a closed position;

FIG. 2 is an isometric view of a front, top, and left side of the industrial truck and the toolbox of FIG. 1 with the toolbox positioned in the first configuration;

FIG. 3 is a left side elevational view of the industrial truck and toolbox of FIG. 1 with the hood of the power module in an open position;

FIG. 4 is an isometric view of a front, top, and left side of the industrial truck and the toolbox of FIG. 3;

FIG. 5 is a right side elevational view of the industrial truck and the toolbox of FIG. 1 with the toolbox positioned in a second configuration;

FIG. 6 is an isometric view of a front, top, and right side of the industrial truck and the toolbox of FIG. 1;

FIG. 7 is an isometric view of a front, top and right side of the toolbox of FIGS. 1-6 in a first position with an outer lid and a first compartment closed;

FIG. 8 is an exploded isometric view of the front, top, and right side of the toolbox of FIG. 7;

FIG. 9 is a front view of the toolbox of FIG. 7;

FIG. 10 is a right side elevational view of the toolbox of FIG. 7;

FIG. 11 is a right side cross section view of the toolbox of FIG. 10 taken along the line 10-10;

FIG. 12 is a rear view of the toolbox of FIG. 7;

FIG. 13 is a rear cross section view of the toolbox of FIG. 12 taken along the line 12-12;

FIG. 14 is a left side elevational view of the toolbox of FIG. 7;

FIG. 15 is a top view of the toolbox of FIG. 7;

FIG. 16 is a top view of the toolbox of FIG. 7 without a clip;

FIG. 17 is a bottom view of the toolbox of FIG. 7 without one or more couplings;

FIG. 18 is a top isometric view of an embodiment of a second compartment of the toolbox of FIG. 17 with the outer lid and the first compartment removed;

FIG. 19 is a bottom view of the toolbox of FIG. 7;

FIG. 20 is a top isometric view of another embodiment of the second compartment of the toolbox of FIG. 7 with the outer lid and the first compartment removed;

FIG. 21 is a bottom view of another embodiment of the toolbox of FIG. 7;

FIG. 22 is a top isometric view of another embodiment of the second compartment of the toolbox of FIG. 21 with the outer lid and the first compartment removed;

FIG. 23 is a bottom view of another embodiment of the toolbox of FIG. 7;

FIG. 24 is a top isometric view of another embodiment of the second compartment of the toolbox of FIG. 23 with the outer lid and the first compartment removed;

FIG. 25 is an isometric view of a front, top, and left side of the toolbox of FIG. 7 in a second position with the outer lid opened and the first compartment closed over the second compartment;

FIG. 26 is an isometric view of a front, top, and left side of the toolbox of FIG. 25 including a mobile device disposed in the first compartment;

FIG. 27 is an isometric view of a rear, top, and left side of the toolbox of FIG. 25;

FIG. 28 is an isometric view of a front, top, and left side of the toolbox of FIG. 7 in a third position with the outer lid closed and the first compartment opened; and

FIG. 29 is an isometric view of a rear, top, and left side of the toolbox of FIG. 7 in a fourth position with both the outer lid and the first compartment opened.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items. As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

The present disclosure relates to a toolbox 400 designed for use with a variety of industrial trucks including forklifts. The industrial truck may be provided in a form of a Class I industrial truck, a Class IV industrial truck, and/or a Class V industrial truck, also known as counter balanced forklifts. Class I industrial trucks may be referred to Electric Motor Rider Trucks with a variation of lift codes including counterbalanced rider type, stand-up, three wheel electric trucks, sit down, cushion tire, or pneumatic or either type tire. Class IV and V industrial trucks may also be referred to as IC engine trucks with or without pneumatic tires and with a variation of lift codes including fork, counterbalanced, cushion tire, and pneumatic tire.

Industrial trucks (e.g., the industrial truck 100) undergo regular servicing or maintenance. The servicing may be done as part of a routine check to ensure the safety and efficiency of the industrial truck and/or to replace or otherwise service an engine or traction battery located in a compartment of the industrial truck. In some instances, when the industrial truck undergoes servicing, the hood (e.g. hood 110) of the engine or traction battery compartment (e.g., compartment 106) may be maneuvered into a different orientation (e.g., lifted or opened) to allow access to the engine or traction battery. One or more couplings (e.g., couplings 408) of the toolbox 400 allow for continuous attachment of the toolbox 400 to the hood. The continuous attachment of the one or more couplings to a mounting surface (e.g., mounting area 150) on the industrial truck such as the hood of the engine or traction battery compartment throughout the servicing or during operation of the industrial truck. Thus, when the engine or traction battery compartment is opened, the toolbox 400 may maneuver with the hood of the compartment and stay coupled or affixed to a surface thereof. In addition, the design of the toolbox 400 allows for the toolbox 400 to be mounted on a variety of mounting areas on the industrial truck and on various types of industrial trucks of different shapes and sizes. The toolbox 400 is also designed to be easily mounted on an industrial truck and moved from one industrial truck to another.

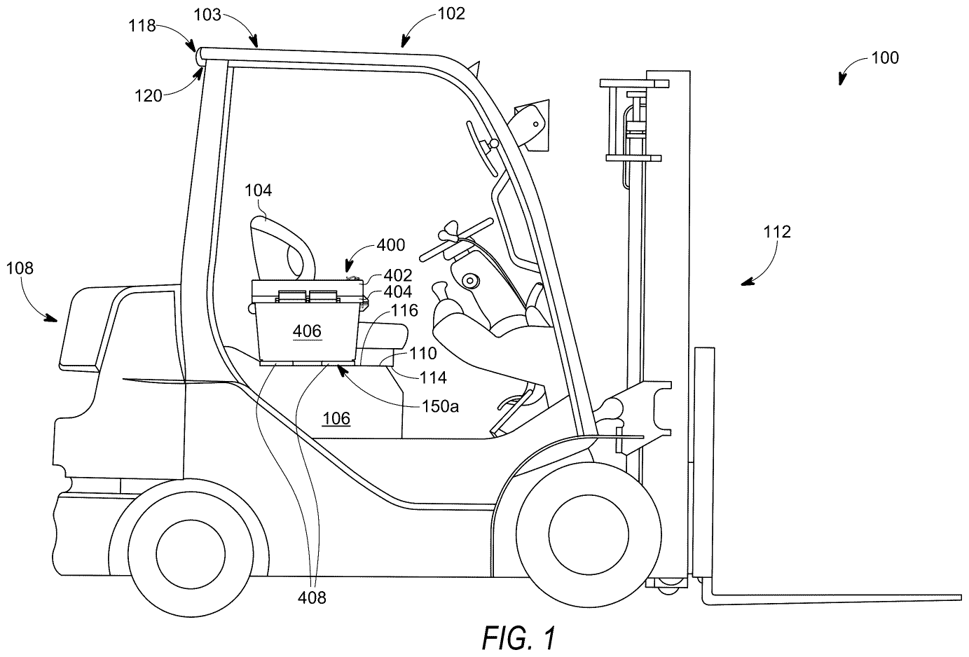

FIGS. 1-6 illustrate an embodiment of an industrial truck 100 and a toolbox 400 positioned thereon. The industrial truck 100 may be provided in the form of a Class I, a Class IV, or a Class V industrial truck such as an electric-powered or gas powered motor rider. In some embodiments, the industrial truck 100 may include an operator cab 102 defined by an overhead guard 103, an operator seat 104 disposed within the operator cab 102, a compartment 106 having a power module 107 disposed therein, a rear portion 108 located behind the operator cab 102, a hood 110 covering the compartment 106, and a forklift portion 112 located in front of the operator cab 102. In some embodiments, a bottom 114 of the operator cab 102 may be coupled to a top 116 of the hood 110.

In some embodiments, the power module 107 is provided in the form of an engine connected to a fuel source. In other embodiments, the power module 107 is provided in the form of a starter battery for an IC engine. In further embodiments, the power module 107 is provided in the form of a traction battery or other battery for driving one or more wheels and lift pumps of the industrial truck 100.

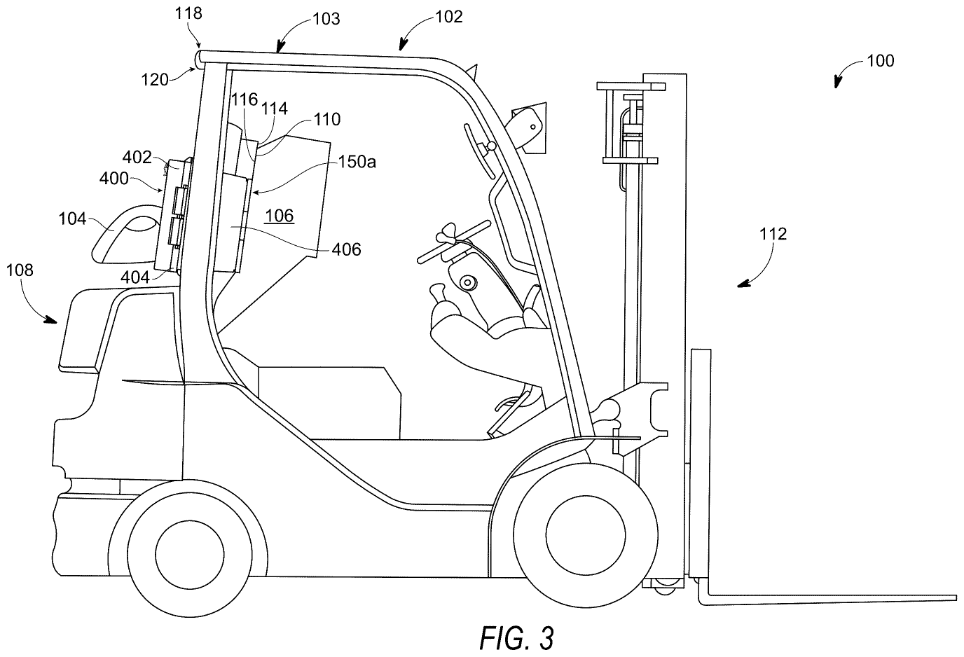

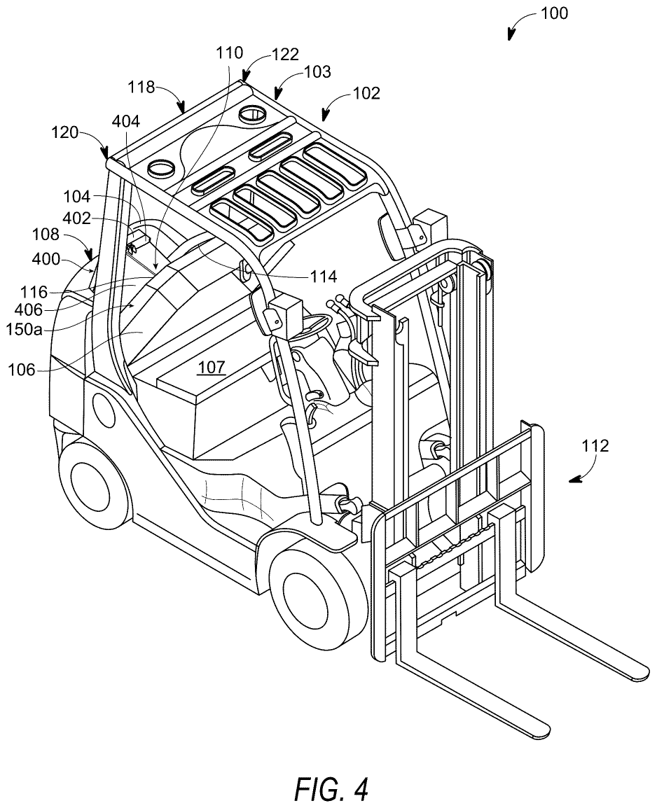

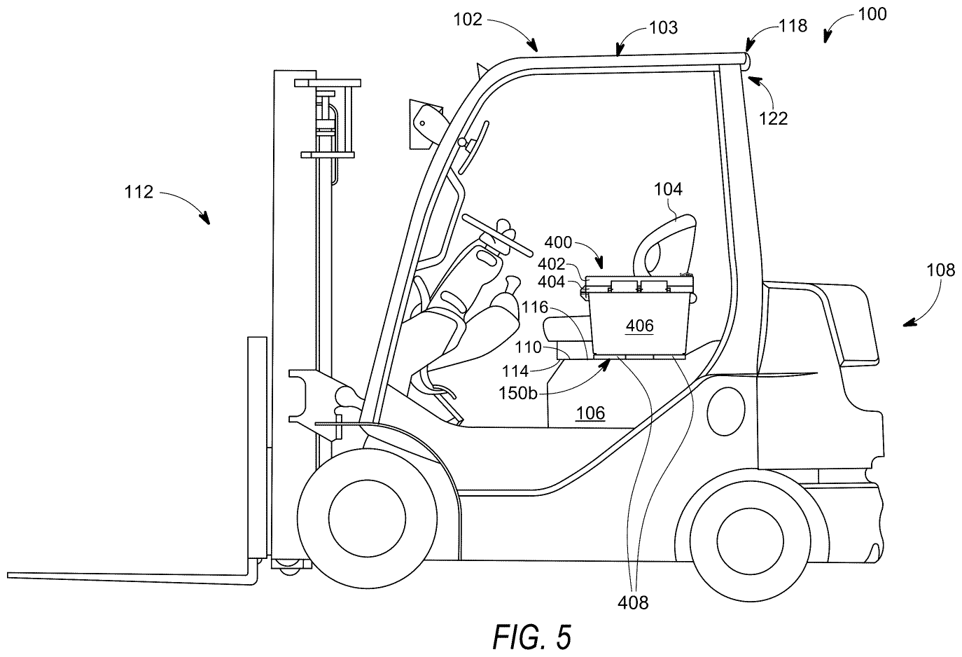

The toolbox 400 can be removably mounted, coupled, or otherwise connected to a mounting area 150 on the industrial truck 100 by one or more couplings 408 (e.g., magnetic plates) of the toolbox 400. In some embodiments, the mounting area 150 is near or adjacent to the operators seat 104. For example, as shown in FIGS. 1-6, in some instances, the mounting area 150 may be on a first side of the operator seat 104 of the industrial truck 100 on the top 116 of the hood 110 of the compartment 106. In some embodiments, the first side of the operator seat 104 is a right side of the operator seat 104 (see, e.g., FIG. 1), and in other embodiments, the first side of the operator seat 104 is a left side of the operator seat 104 (see, e.g., FIG. 5). When the hood 110 of the compartment 106 transitions from a closed position as shown in FIGS. 1, 2, 5, and 6, to an opened or lifted position as shown in FIGS. 3 and 4, and vice versa, (e.g., to enable access to the power module) the toolbox 400 may stay affixed to the hood 110 via the one or more couplings 408. In addition, in some embodiments, the toolbox 400 may be positioned such that the toolbox 400 fits between the operator seat 104 and a rear portion 118 of the overhead guard 103 when the hood 110 is opened (e.g., for access to the power module). For example, in some embodiments, the toolbox 400 may be positioned such that the toolbox 400 fits between the operator seat 104 and a right rear portion 120 of the overhead guard 103 when the hood 110 is opened (e.g., for access to the power module; see e.g., FIG. 3). In other embodiments, the toolbox 400 may be positioned such that the toolbox 400 fits between the operator seat 104 and a left rear portion 122 of the overhead guard 103 when the hood 110 is opened (e.g., for access to the power module).

Furthermore, the toolbox 400 can be removably mounted so that the toolbox 400 sits flat or substantially flat on the mounting area 150 of the industrial truck 100. The toolbox 400 may be designed to be mounted and opened without the toolbox 400 substantially sliding or otherwise moving away from the mounting area 150. The toolbox 400 may be designed to enable individual access to one or more compartments of the toolbox 400 (e.g., a first compartment 404 and/or a second compartment 406). When the industrial truck 100 is in operation, the one or more couplings 408 can keep the toolbox 400 securely attached to the industrial truck 100 so the toolbox 400 does not fall off the industrial truck 100.

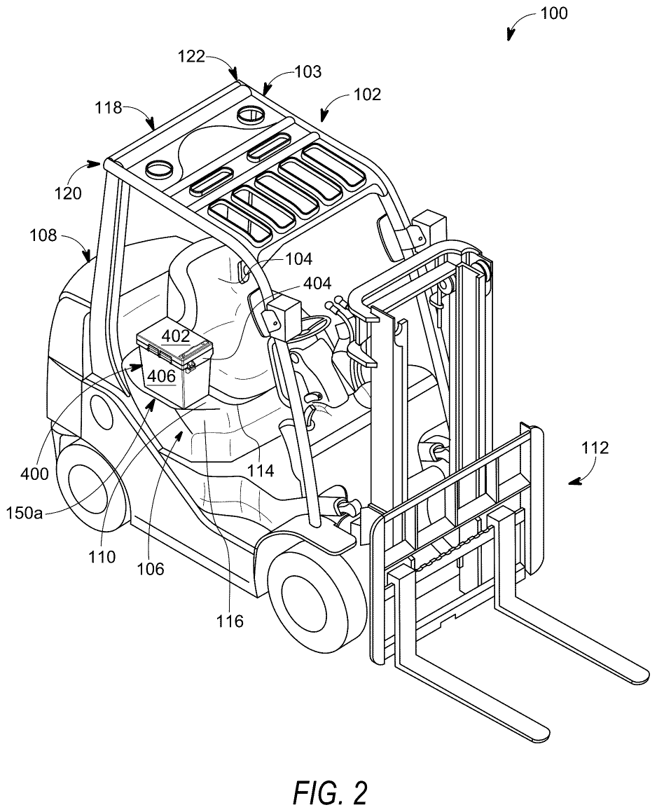

FIGS. 1-4 illustrate the industrial truck 100 with the toolbox 400 positioned in a first configuration. The toolbox 400 can be removably mounted to a mounting area 150a on the industrial truck 100 by the one or more couplings 408. The mounting area 150a may be on a first side of the operator seat 104. For example, as shown in FIGS. 1 and 2, the toolbox 400 may be positioned on a right side of the operator seat 104 of the industrial truck 100 on the top 116 of the hood 110 of the compartment 106. When the hood 110 of the compartment 106 is opened as shown in FIGS. 3 and 4 or closed as illustrated in FIGS. 1 and 2, the toolbox 400 may stay affixed to the hood 110 via the one or more couplings 408. In addition, the toolbox 400 can be removably mounted so that the toolbox 400 sits flat or substantially flat on the mounting area 150a of the industrial truck 100. The toolbox 400 can be mounted to open away from the operator so that the operator can easily access the inside of the toolbox 400 when seated in the operator seat 104. Further, when the industrial truck 100 is in operation, the one or more couplings 408 may keep the toolbox 400 securely coupled to the industrial truck 100, not allowing the toolbox 400 to shift or uncouple therefrom.

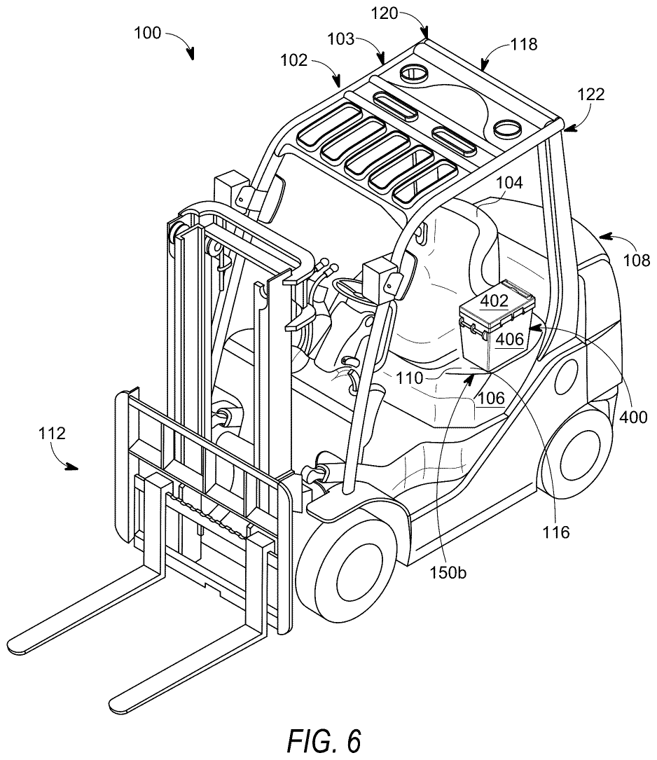

FIGS. 5 and 6 illustrate the industrial truck 100 with the toolbox 400 positioned in a second configuration. The toolbox 400 can be removably mounted to a mounting area 150b on the industrial truck 100 by the one or more couplings 408. The mounting area 150b may on a first side of the operator seat 104. For example, the toolbox 400 may be positioned on a left side of the operator seat 104 of the industrial truck 100 on the top 116 if the hood 110 of the compartment 106. When the hood 110 of the compartment 106 is opened or closed, the toolbox 400 may stay affixed to the hood 110 via the one or more couplings 408. In addition, the toolbox 400 can be removably mounted so that the toolbox 400 sits flat or substantially flat on the mounting area 150b of the industrial truck 100. The toolbox 400 can be mounted to open away from the operator so that the operator can easily access the inside of the toolbox 400 when seated in the operator seat 104. Further, when the industrial truck 100 is in operation, the one or more couplings 408 may keep the toolbox 400 securely coupled to the industrial truck 100, not allowing the toolbox 400 to shift or uncouple therefrom.

In other embodiments, the toolbox 400 may be positioned in additional configurations. For example, the toolbox 400 can be removably mounted to a mounting area 150 that is located outside of the operator cab 102 such as the rear portion 108 of the industrial truck 100.

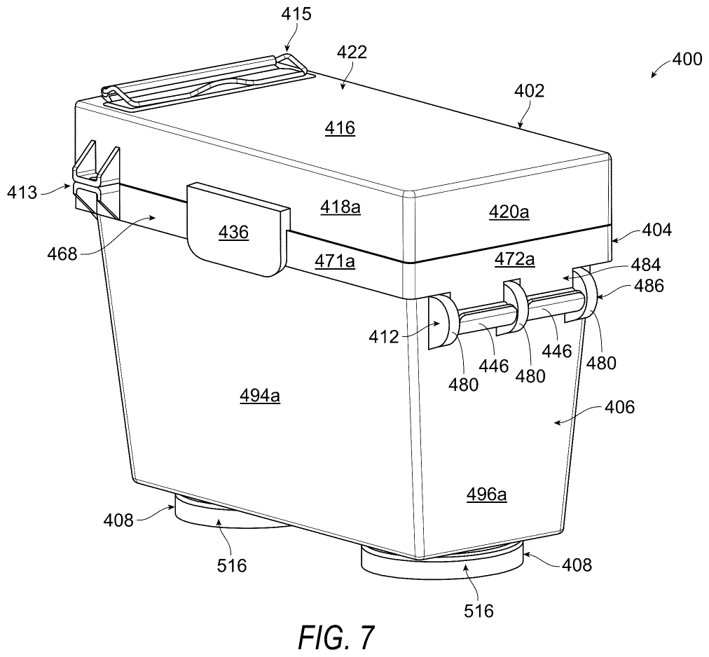

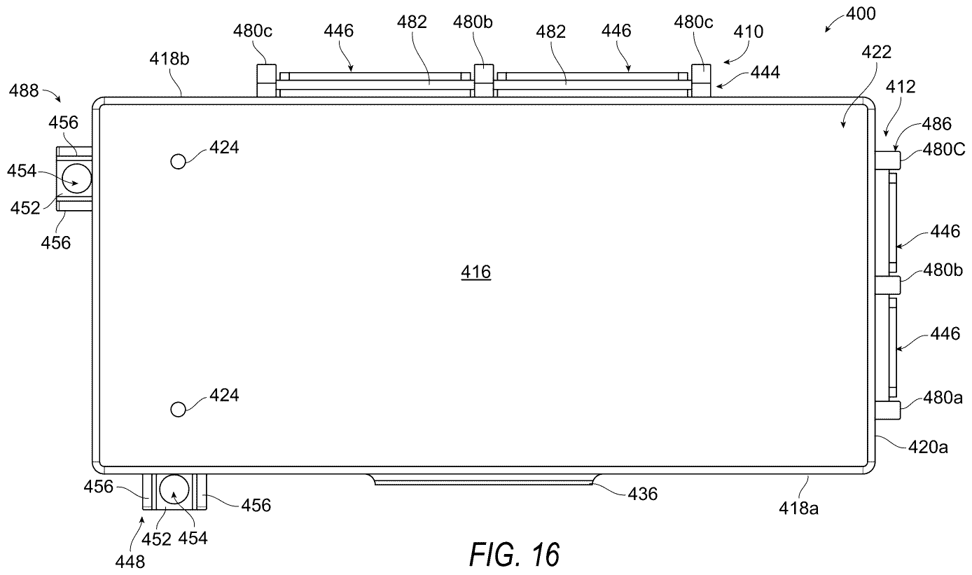

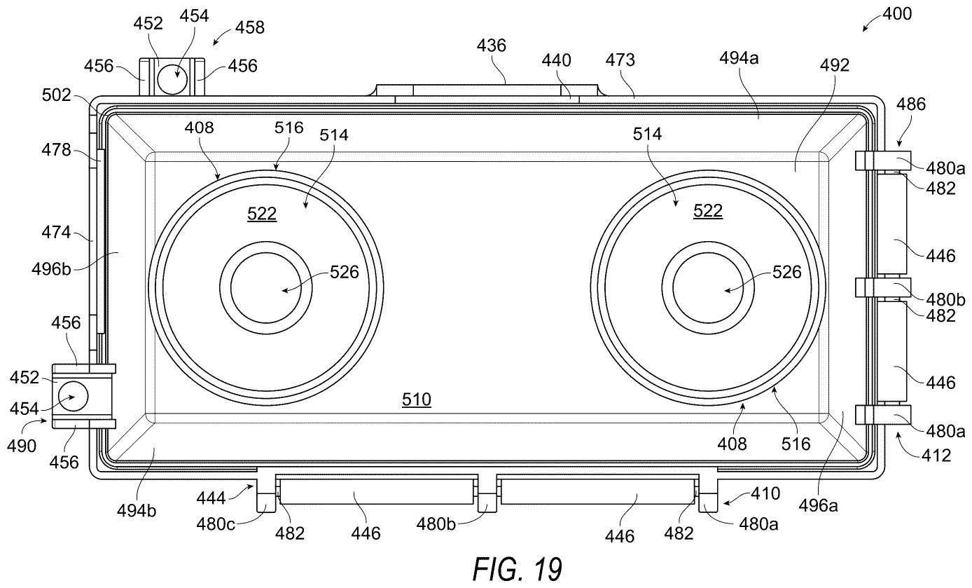

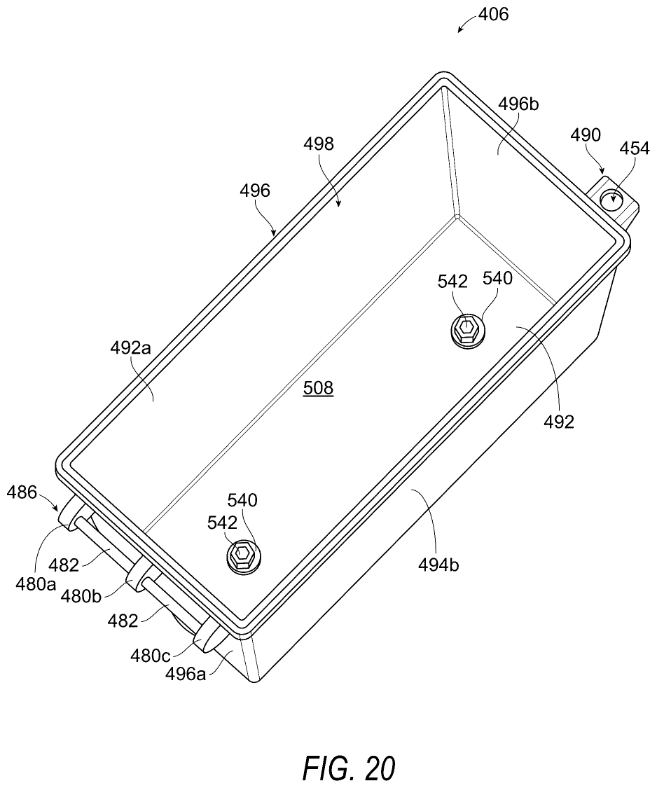

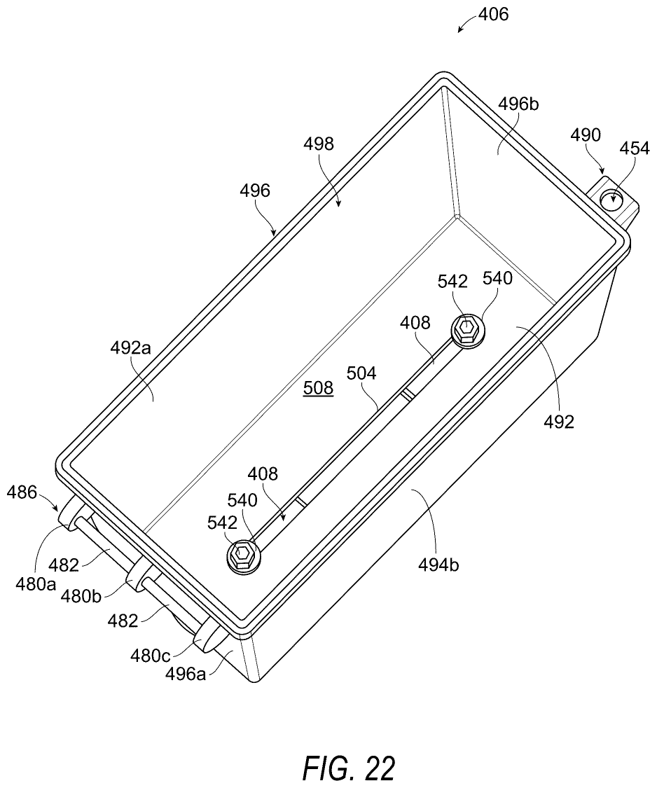

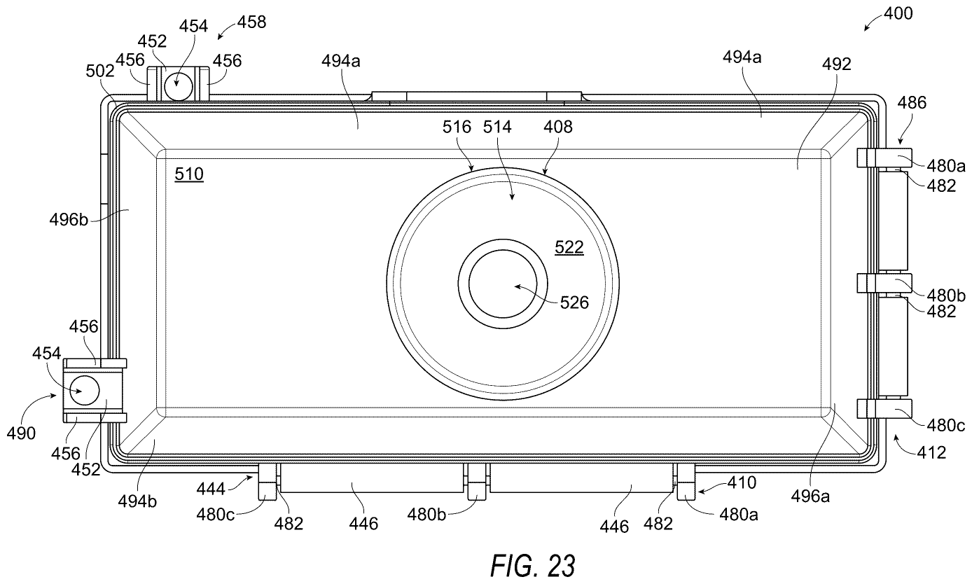

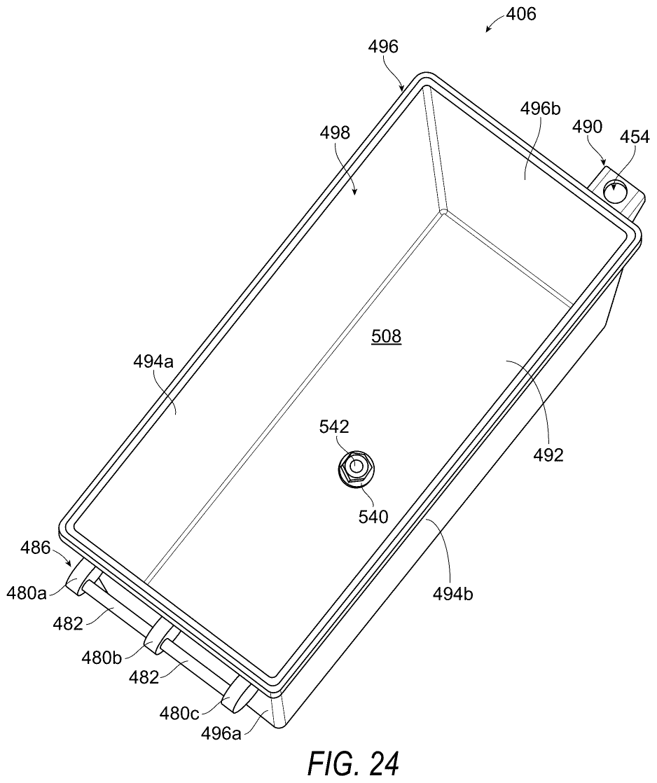

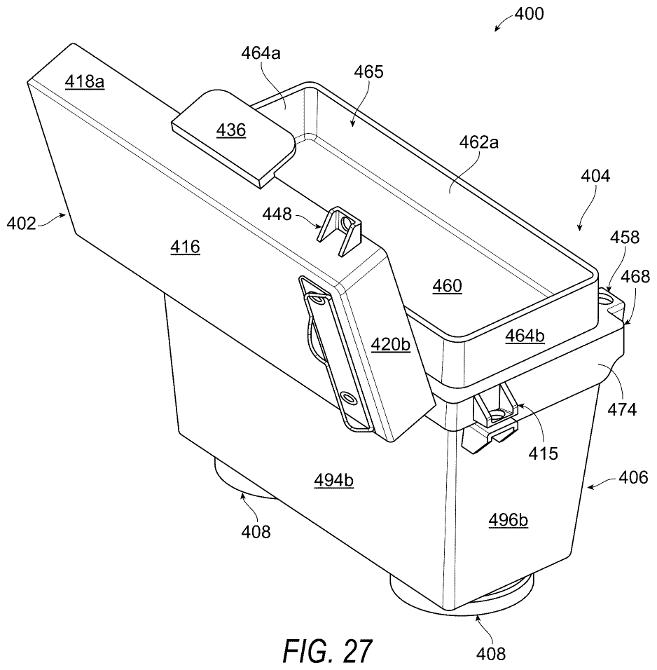

Turning to FIGS. 7-29, the toolbox 400 may include an outer lid 402, a first compartment 404, a second compartment 406, and one or more couplings 408. The outer lid 402, the first compartment 404, and the second compartment 406 may be provided in the form of nesting or stacking compartments within the toolbox 400. For example, the outer lid 402 may cover the first compartment 404, and the first compartment 404 may fit within the second compartment 406 and a portion of the first compartment 404 may cover the second compartment 406. Where used herein, the “lid” can include any verticl surface designed to hold material, items, or similar, in the interior of the toolbox 400. The toolbox 400 may also include elements to movably couple the outer lid 402 to the first compartment 404 and the first compartment 404 to the second compartment 406. In some embodiments, the outer lid 402 may be movably coupled to the first compartment 404 via a first connection mechanism 410, and the first compartment 404 may be movably coupled to the second compartment 406 via a second connection mechanism 412. In some embodiments, the first and second connection mechanisms 410, 412 may each be provided in the form of a hinge, for example, a strap hinge, barrel hinge, butt hinge, corner hinge, piano hinge, lift off screw mount hinge, plastic molded hinge, living plastic hinge, roller hinge, etc. In other embodiments, the first and second connection mechanisms 410, 412 may be any other suitable movable connection mechanism known in the art. The toolbox 400 may include a first locking mechanism 413 to facilitate locking or otherwise securing the outer lid 402 to the first compartment 404 and a second locking mechanism 414 to facilitate locking or otherwise securing the first compartment 404 to the second compartment 406. The toolbox 400 may further include an optional clip 415 disposed on the outer lid 402.

Some or all of the components of the toolbox 400 (e.g., the outer lid 402, the first compartment 404, the second compartment 406, the couplings 408, the first connection mechanism 410, the second connection mechanism 412, the first locking mechanism 413, the second locking mechanism 414, and/or the clip 415) made be made out of plastic, metal, metal alloys, a combination of metal, metal alloys, and/or plastic, or any other suitable materials. In some instances, some or all of the components of the toolbox 400 may be made from injection molding or 3D printing.

The outer lid 402 of the toolbox 400 may include a top plate 416 having a rectilinear shape or substantially rectilinear shape. The outer lid 402 may include two first sides 418a and 418b and two second sides 420a and 420b extending downward from the top plate 416. The two first sides 418a, 418b may have the same or substantially the same size and shape as each other and may be parallel or substantially parallel to one another. Similarly, the two second sides 420a, 420b may have the same or substantially the same size and shape as each other and may be parallel or substantially parallel to one another. In some embodiments, each of the two first sides 418a, 418b is longer than each of the two second sides 420a, 420b.

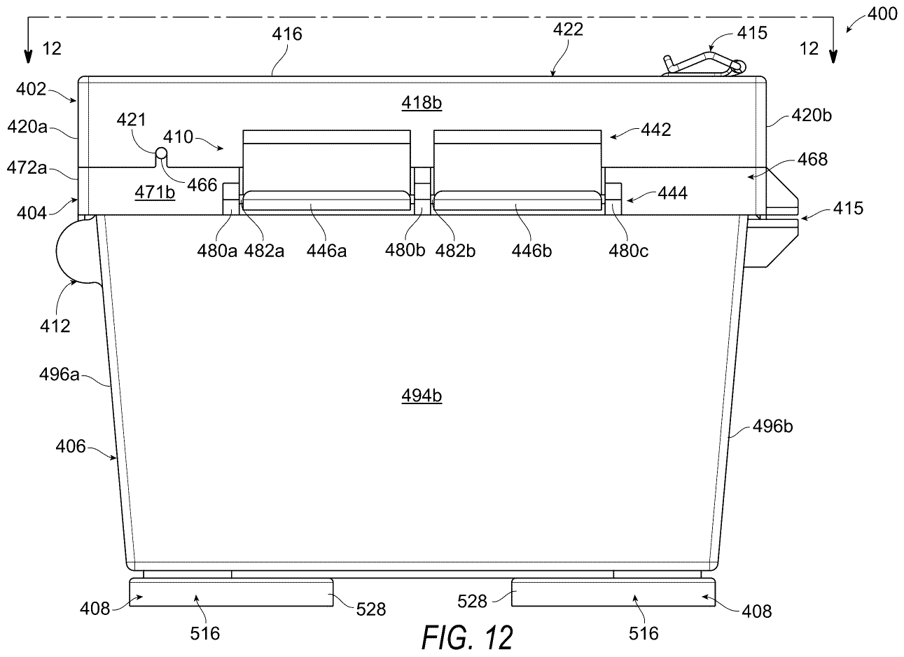

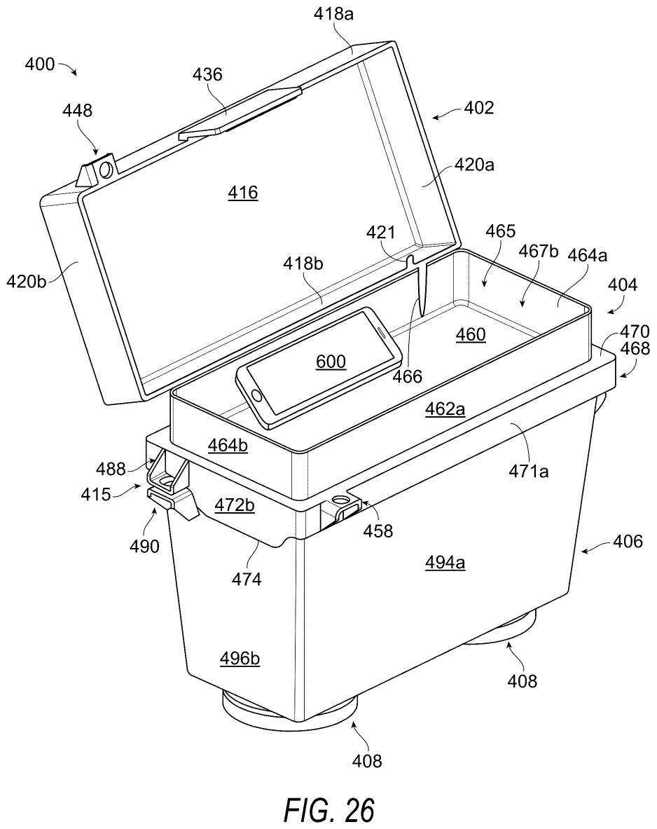

In some embodiments, the outer lid 402 may also include a cutout 421 that is disposed on and extends through one of the two first sides 418a, 418b or one of the two second sides 420a, 420b. In one embodiment, the cutout 421 is disposed on and extends through the first side 418b (see, e.g., FIGS. 12 and 26). The cutout 421 may align with all or a portion of a hole or aperture (e.g., charge port 466) in the first compartment 404 and be designed to receive a charging cable, cord, and/or port of a mobile device 600 such as tablet, laptop, or cell phone. The cutout 421 may be any size and shape suitable for allowing the charging cable, cord, and/or port to pass through the cutout 421.

The top plate 416 may include a top surface 422 having one or more through-holes 424 the extend entirely through the top surface 422. The through-holes 424 may be used to attach the clip 415 to the top surface 422 of the outer lid 402. The clip 415 may include a clip portion 426, a clip mounting plate 428, and one or more springs 432. The clip mounting plate 428 may include one or more clip mounting holes 430. One or more screws 434, rivets, or other coupling mechanisms may be used to attach the clip mounting plate 428 to the top surface 422 of the outer lid 402 via the one or more clip mounting holes 430 and the through-holes 424. The clip portion 426 may be attached to or otherwise engaged with the clip mounting plate 428 via the one or more springs 432. In some embodiments, the clip portion 426 is provided in the form of a metal wire. The one or more springs 432 may be biased such that the clip portion 426 engages with the top surface 422 of the outer lid 402 unless the clip portion 426 is lifted or otherwise moved away from the top surface 422. In some embodiments, paper, pens, pencils, markers, a clip board, and/or other items may be attached to the top surface 422 of the outer lid 402 via the clip 415. In some embodiments, the toolbox 400 may be positioned on the industrial truck 100 so that the top surface 422 of the outer lid 402 is approximately elbow height for an operator seated in the operator seat 104, such that the top surface 422 of the outer lid 402 is a writing surface.

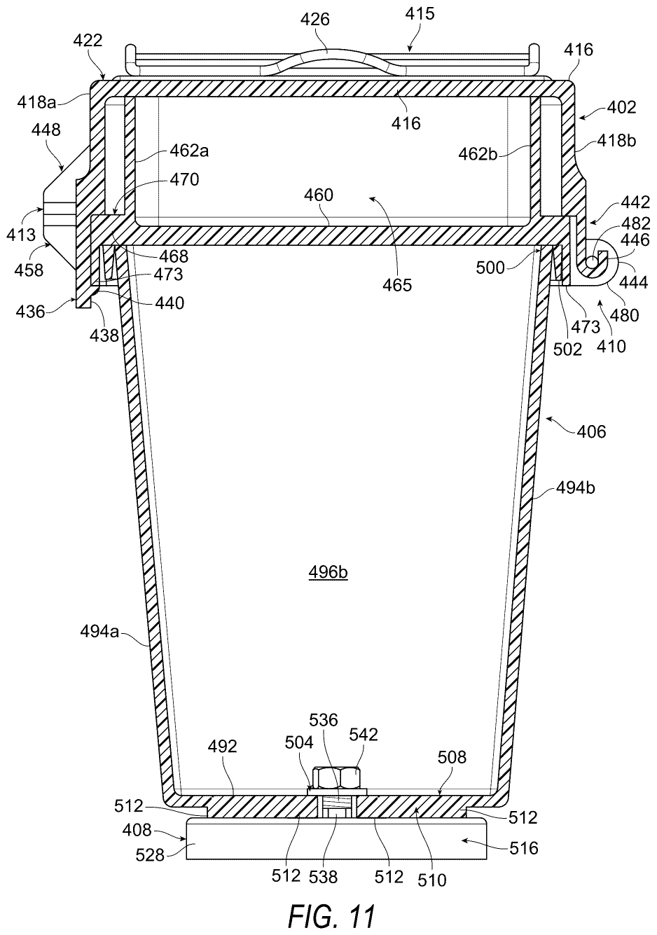

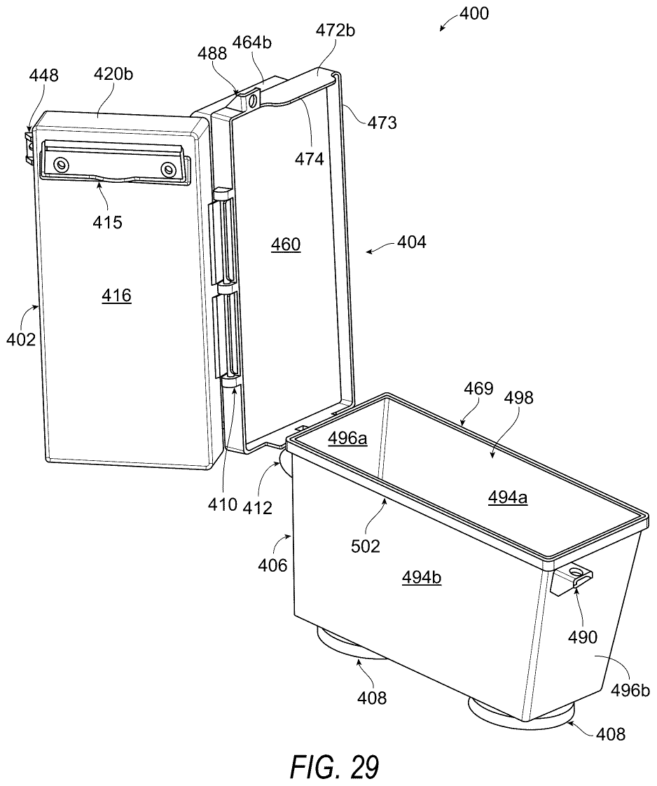

The outer lid 402 may also include an outer lid latch 436 that is integrally formed with or otherwise attached to an exterior surface of one of the first sides 418a, 418b or one of the second sides 420a, 420b of the outer lid 402. In some embodiments, the outer lid latch 436 extends downwards and away from the top plate 416 of the outer lid 402. In some embodiments, the outer lid latch 436 may be disposed in a center area of one of the first sides 418a, 418b or one of the second sides 420a, 420b of the outer lid 402. For example, as shown in FIGS. 7-11, the outer lid latch 436 may extend downward from, and be integrally formed with, the first side 418a and disposed at a center area thereof. In other embodiments, the outer lid latch 436 may be offset from a center area of one of the first sides 418a, 418b or one of the second sides 420a, 420b. The outer lid latch 436 may include an inner lid latch wall 438. A lid latch protrusion 440 may extend outwards from the inner lid latch wall 438. The lid latch protrusion 440 is best shown in the cross section view of FIG. 11. The outer lid latch 436 may be used to fasten the outer lid 402 to the first compartment 404 via the lid latch protrusion 440 so that the outer lid 402 stays attached to and/or closed over the first compartment 404 even if the first compartment 404 is opened as shown in FIG. 29.

The outer lid 402 of the toolbox 400 may include one or more first hinge attachment members 442. In some instances, two first hinge attachment members 442a and 442b may be provided as shown in FIG. 12. The one or more first hinge attachment members 442 may extend downwards from the outer lid 402 away from the top plate 416 (see, e.g., FIG. 11). More specifically, in some embodiments, the one or more first hinge attachment members 442 may be formed integrally with or may be otherwise attached to and extend down from one of the first sides 418a, 418b or one of the second sides 420a, 420b. In addition, in some embodiments, the one or more first hinge attachment members 442 may disposed opposite the outer lid latch 436. For example, the one or more first hinge attachment members 442 may disposed on the first side 418b.

The one or more first hinge attachment members 442 may be designed to movably engage one or more first hinge axis members 444 disposed on the first compartment 404. For example, as best shown in FIGS. 11 and 12, the one or more first hinge attachment members 442 may be provided in the form of one or more hooks 446 that extend downwards from the outer lid 402. In some embodiments, two hooks 446a, 446b may be provided as best shown in FIG. 12. In some embodiments, the one or more first hinge attachment members 442 may partially or fully surround a portion of the one or more first hinge axis members 444 such that the outer lid 402 is movable (e.g., the outer lid 402 can open and/or close) with respect to the first compartment 404. The one or more first hinge attachment members 442 and the one or more first hinge axis members 444 may together form the first connection mechanism 410. In some embodiments, the outer lid 402 of the toolbox 400 may be opened in a direction that is away from the operator seat 104, such that the outer lid latch 436 faces a right side or a left side of the operator seat 104 and the first connection member 410 faces an exterior of the industrial truck 100.

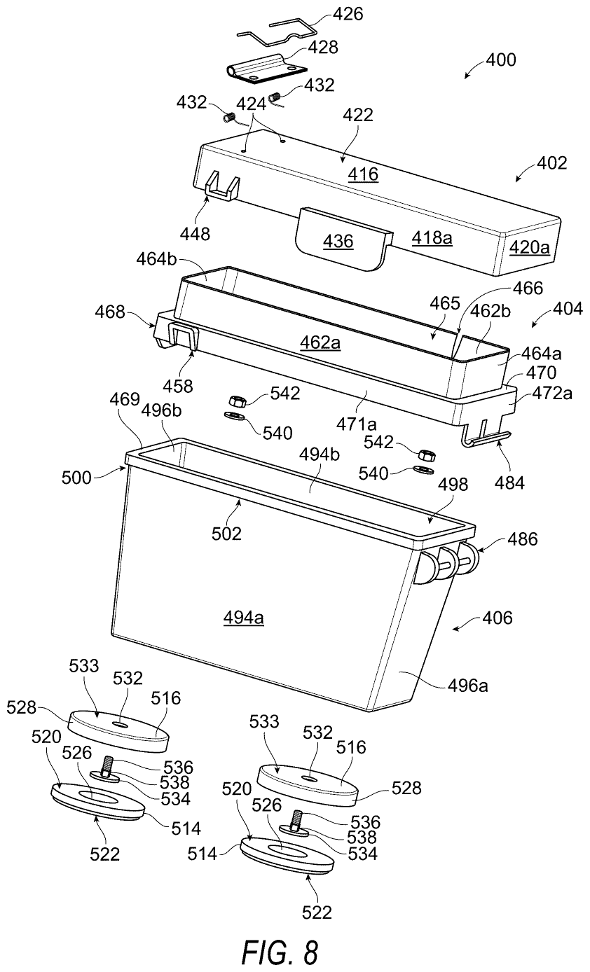

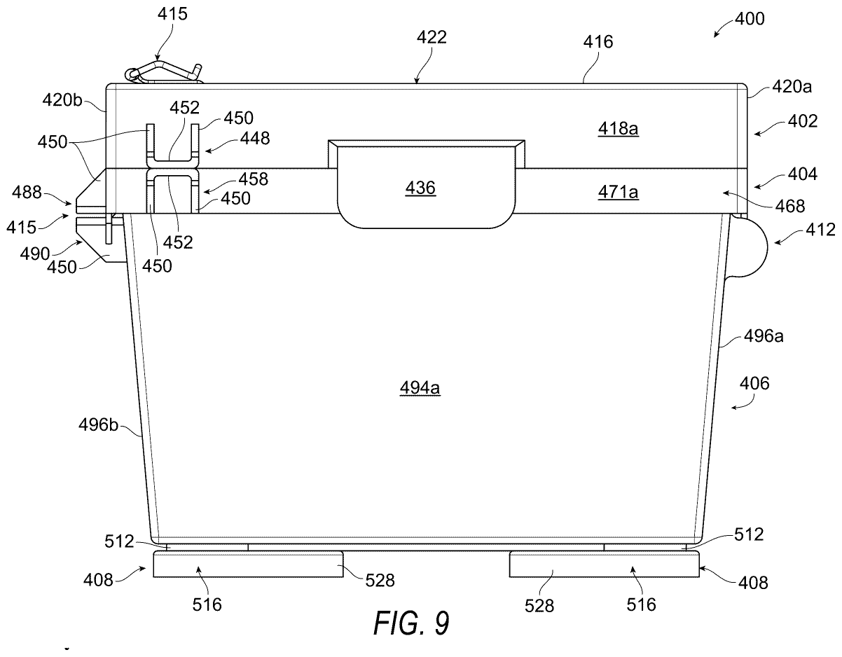

The outer lid 402 may also include a first top lock portion 448 of the first locking mechanism 413. The first top lock portion 448 may extend outwards from the exterior surface of one of the first sides 418a, 418b or one of the second sides 420a, 420b. The first top lock portion 448 may be formed integrally with or otherwise attached to the exterior surface of one of the first sides 418a, 418b or one of the second sides 420a, 420b of the outer lid 402. For example, as shown in FIGS. 8 and 9, the first top lock portion 448 may be integrally formed with and extend out from the exterior surface of the first side 418a of the outer lid 402.

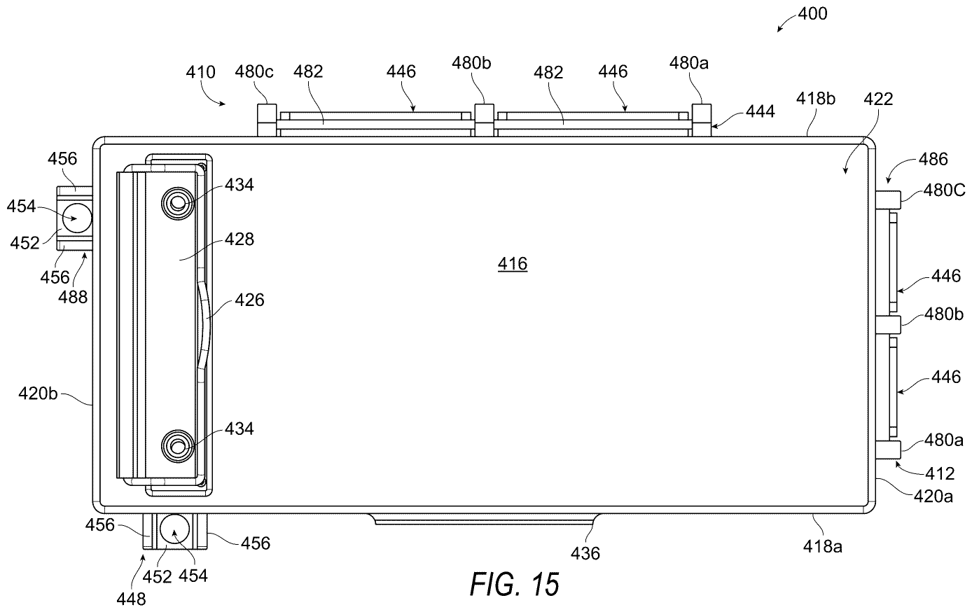

In some embodiments, the first top lock portion 448 may be provided in the form of a U-shape protrusion as best shown in FIG. 9. The first top lock portion 448 may include two lock sides 450 and a lock base 452 disposed between the two lock sides 450. The two lock sides 450 and the lock base 452 may be integrally formed with each other or otherwise attached to one another by known attachment methods in the art. The lock base 452 may include one or more apertures 454 that extend therethrough. In some embodiments, one aperture 454 may be disposed in a center of the lock base 452, as shown in FIGS. 15-17, for example. In other embodiments, two apertures 454 may be disposed in the lock base 452. The one or more apertures 454 may be configured to receive, store, and/or transport a shackle portion of a padlock or other attachment mechanism and/or configured to receive, store, and/or transport a writing instrument such as a pen, pencil, or marker.

The first top lock portion 448 may be positioned on the outer lid 402 so that the first top lock portion 448 aligns or substantially aligns with a first bottom lock portion 458 disposed on the first compartment 404. In some embodiments, the first bottom lock portion 458 may have the same size, shape, and components as the first top lock portion 448. For example, as shown in FIGS. 7-10, the first bottom lock portion 458 may be a mirror image of the first top lock portion 448 and also include two lock sides 450, lock base 452, and one or more apertures 454. Furthermore, when the outer lid 402 is closed, the one or more apertures 454 of the first top lock portion 448 may align or substantially align with the one or more apertures 454 of the first bottom lock portion 458.

In some embodiments, the two lock sides 450 of the first top lock portion 448 and the first bottom lock portion 458 of the first locking mechanism 413 may be parallel or substantially parallel to each other and may each have top portion 456 that has a slanted shape. The slanted shape of the top portion 456 of the lock sides 450 may facilitate the positioning of a shackle of a padlock or other attachment mechanism through the one or more apertures 454 in the lock base 452 of the first top lock portion 448 and/or the one or more apertures 454 in the lock base 452 of the first bottom lock portion 458, and vice versa, to secure the outer lid 402 to the first compartment 404.

In other embodiments, the slanted shape of the top portion 456 of the lock sides 450 may facilitate the positioning of a pen, pencil, marker, or other writing instrument through the one or more apertures 454 in the lock base 452 of the first top lock portion 448 and the one or more apertures 454 in the lock base 452 of the first bottom lock portion 458, and vice versa.

The first compartment 404 may include a base plate 460 having a rectilinear shape or substantially rectilinear shape. The base plate 460 may include two first walls 462a and 462b and two second walls 464a and 464b extending upwards from the base plate 460. The two first walls 462 together with the two second walls 464 may define an internal cavity 465. The internal cavity 465 may be configured to receive, stop, and/or transport a mobile device such as a tablet, laptop, or cell phone (see, e.g., FIG. 26), tools, parts, or other items. The two first walls 462a, 462b may have the same or substantially the same size and shape as each other and may be parallel or substantially parallel to one another. Similarly, the two second walls 464a, 464b may have the same or substantially the same size and shape as each other and may be parallel or substantially parallel to one another. In some embodiments, each of the two first walls 462a, 462b is longer than each of the two second walls 464a, 464b.

In some embodiments, the first compartment 404 may include a charge port 466 provided in the form of an aperture that is disposed on and extends through one of the two first walls 462a, 462b or one of the two second walls 464a, 464b. In one embodiment, the charge port 466 is disposed on and extends through the first wall 462b (see, e.g., FIGS. 1, 12, and 26). The charge port 466 may align with all or a portion of the cutout 421 in the outer lid 402 and be designed to receive a charging cable, cord, and/or port of a mobile device such as a tablet, laptop, or cell phone. The charge port 466 may be any size and shape suitable for allowing the charging cable, cord, and/or port to pass through the charge port 466.

The first compartment 404 may also include an outer flange portion 468. The outer flange portion 468 may have a shape and size that are suitable for nesting with or otherwise covering a top outer rim 469 of the second compartment 406. In some embodiments, the outer flange portion 468 may include an outer flange ledge 470 that extends outward from the base plate 460, and around a perimeter of the base plate 460. The outer flange ledge 470 may be integrally formed or otherwise attached to the base plate 460.

In some embodiments, the outer flange portion 468 may also include two first outer flange walls 471a and 471b and two second outer flange walls 472a and 472b that extend downwards from the outer flange ledge 470, and around a perimeter of the outer flange ledge 470. The two first outer flange walls 471a, 471b and the two second outer flange walls 472a, 472b may be integrally formed or otherwise attached to the outer flange ledge 470. The two first outer flange walls 471a, 471b may have the same or substantially the same size and shape as each other and may be parallel or substantially parallel to one another. Similarly, the two second outer flange walls 472a, 472b may have the same or substantially the same size and shape as each other and may be parallel or substantially parallel to one another. In some embodiments, each of the two first outer flange walls 471a, 471b is longer than each of the two second outer flange walls 472a, 472b.

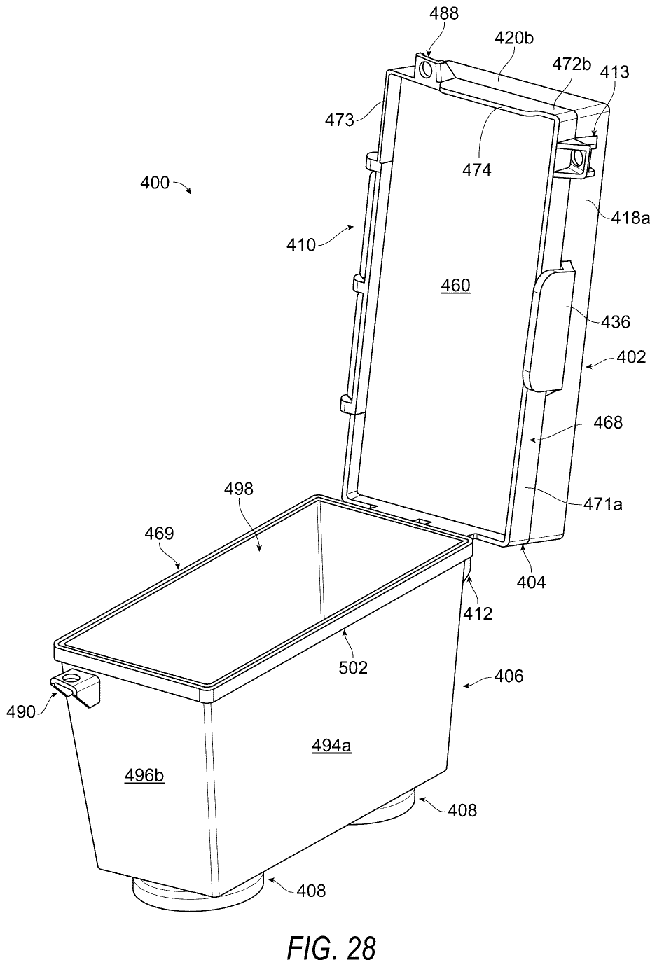

In some embodiments, as shown in FIG. 11, the outer flange portion 468 may include a bottom flange edge 473 that extends around a bottom perimeter of the two first outer flange walls 471a, 471b and the two second outer flange walls 472a, 472b (see, e.g., FIGS. 28 and 29). The lid latch protrusion 440 of the outer lid latch 436 may engage the bottom flange edge 473 of the outer flange portion 468 to fasten the outer lid 402 to the first compartment 404.

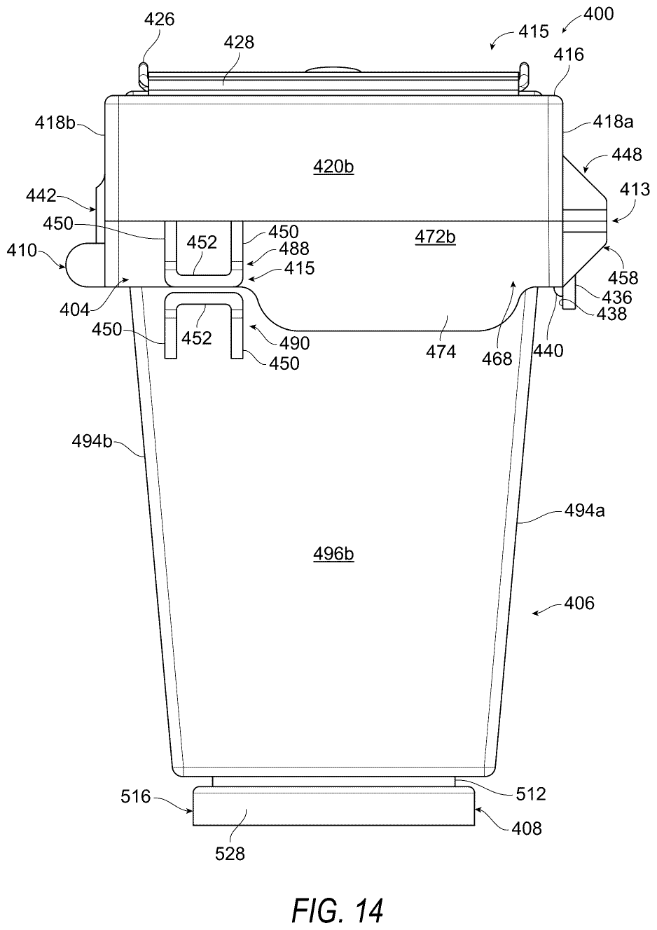

The first compartment 404 may also include a compartment latch 474 that is integrally formed with or otherwise attached to one of the first outer flange walls 471a, 471b or one of the second outer flange walls 472a, 472b of the first compartment 404. In some embodiments, the compartment latch 474 extends downwards from a bottom area of one of the two first outer flange walls 471a, 471b or from one of the two second outer flange walls 472a, 472b of the outer flange portion 468 of the first compartment 404. In some embodiments, the compartment latch 474 may be positioned off-center from or in a center area of one of the first outer flange walls 471a, 471b or one of the second outer flange walls 472a, 472b of the first compartment 404. For example, as best shown in FIG. 14, the compartment latch 474 may extend downward from and be integrally formed with the second outer flange wall 472b.

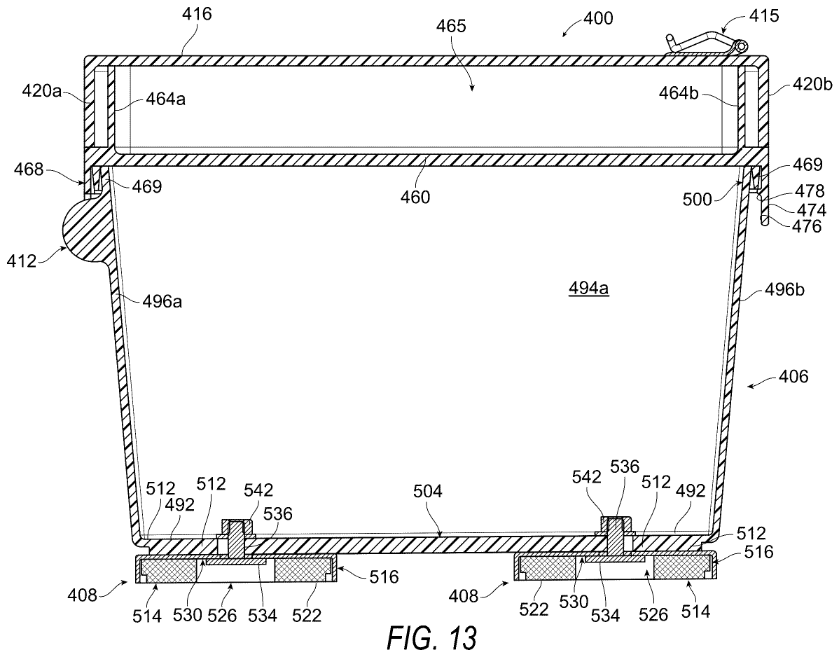

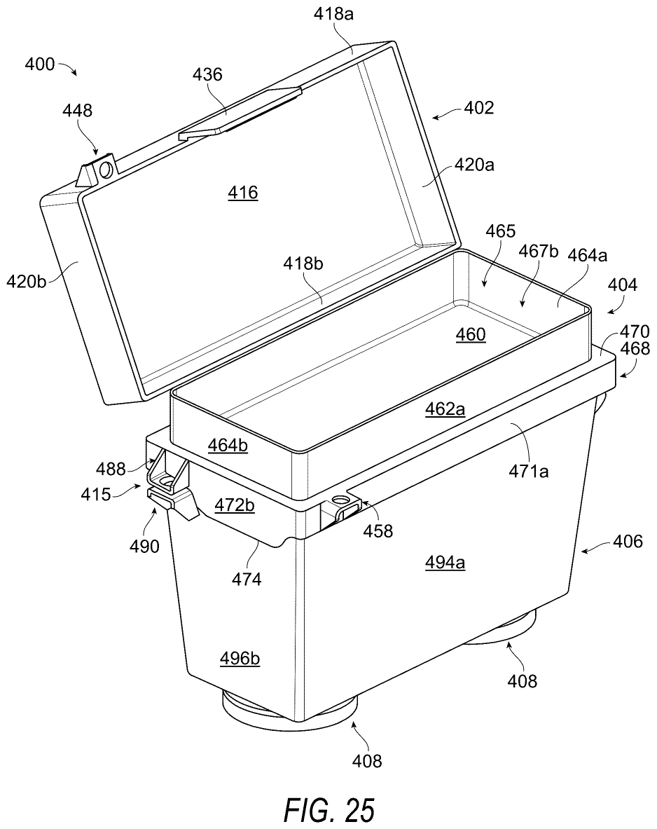

The compartment latch 474 may include an inner compartment latch wall 476. In some embodiments, a compartment latch protrusion 478 may extend outwards from the inner compartment latch wall 476. The compartment latch protrusion 478 is best shown in the cross section view of FIG. 13. The compartment latch 474 may be used to fasten the first compartment 404 to the second compartment 406 via the compartment latch protrusion 478 so that the first compartment 404 stays attached to and/or closed over the second compartment 406 even if the outer lid 402 is opened as shown in FIGS. 25-27.

The first compartment 404 of the toolbox 400 may include the one or more first hinge axis members 444 of the first connection mechanism 410. The one or more first hinge axis members 444 may include one or more attachment hubs 480 and one or more hinge rods 482 that extend through the one or more attachment hubs 480 or therebetween. For example, as shown in FIGS. 12 and 15-17, the one of more first hinge axis members 444 may include three attachment hubs 480a, 480b, and 480c and two hinge rods 482a and 482b; the hinge rod 482a may extend between attachment hubs 480a and 480b and the hinge rod 482b may extend between attachment hubs 480b and 480c. In other instances, more or less than three attachment hubs 480 may be provided and more or less than two hinge rods 482 may be used. For example, in some embodiments, multiple attachment hubs 480 may be provided, but only a single hinge rod 482 may be used (e.g., the single hinge rod may extend between the outer most attachment hubs and may extend through any attachment hubs placed between the outer most attachment hubs).

The one or more first hinge axis members 444 may be disposed on one of the first outer flange walls 471a, 471b or one of the second outer flange walls 472a, 472b. For example, as shown in FIGS. 11-14, the one or more first hinge axis members 444 may disposed on the first outer flange wall 471b. In some instances, the one or more first hinge axis members 444 may be designed to enable the outer lid 402 to move (e.g., open and/or close) with respect to the first compartment 404 (e.g., the hooks 446 of the one or more first hinge attachment members 442 disposed on the outer lid 402 may movably engage with the hinge rods 482 of the one or more first hinge axis members 444 disposed on the first compartment 404).

The first compartment 404 may also include one or more second hinge attachment members 484. In some instances, two second hinge attachment members 484a and 484b may be provided as shown in FIG. 7. The one or more second hinge attachment members 484 may extend downwards from the outer flange portion 468 away from the base plate 460. More specifically, in some embodiments, the one or more second hinge attachment members 484 may be formed integrally with or may be otherwise attached to and extend down from one of the first outer flange walls 471a, 471b or one of the second outer flange walls 472a, 472b. In addition, in some embodiments, the one or more second hinge attachment members 484 may disposed opposite the compartment latch 474. For example, the one or more second hinge attachment members 484 may disposed on the second outer flange wall 472a.

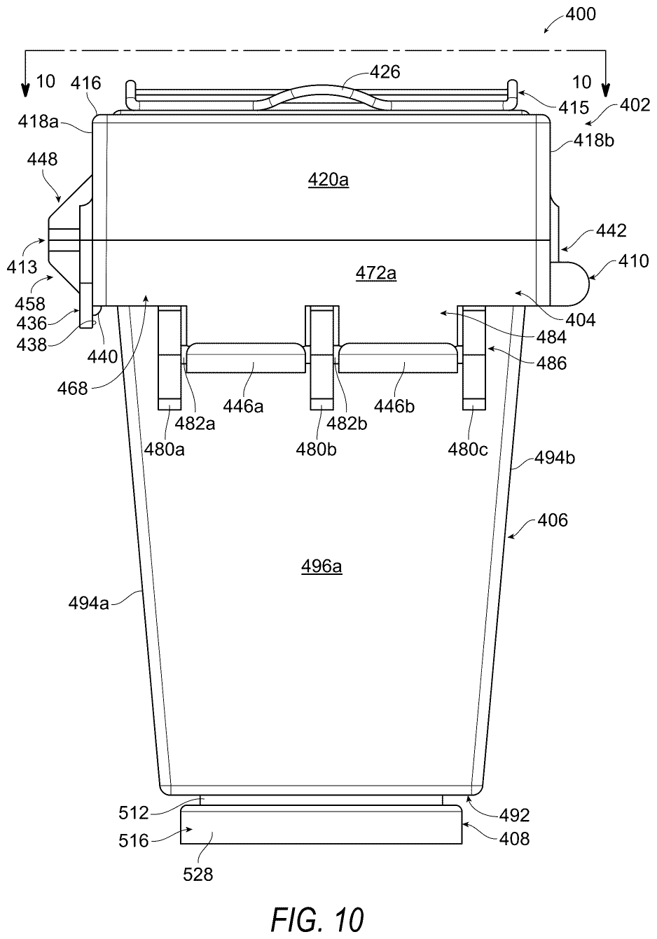

The one or more second hinge attachment members 484 may be designed to movably engage one or more second hinge axis members 486 disposed on the second compartment 406. In some embodiments, the second hinge attachment members 484 may be the same as or similar to the one or more first hinge attachment members 442. For example, as best shown in FIGS. 7 and 8, the one or more second hinge attachment members 484 may be provided in the form of one or more hooks 446 that extend downwards from the outer flange portion 468. In some embodiments, two hooks 446a, 446b may be provided as best shown in FIG. 10. In some embodiments, the one or more second hinge attachment members 484 may partially or fully surround a portion of the one or more second hinge axis members 486 such that the first compartment 404 is movable (e.g., the first compartment 404 can open and/or close) with respect to the second compartment 406. The one or more second hinge attachment members 484 and the one or more second hinge axis members 486 may together form the second connection mechanism 412.

As discussed above, the first compartment 404 may include the first bottom lock portion 458 of the first locking mechanism 413. The first bottom lock portion 458 may extend outwards from an exterior surface of one of the first outer flange walls 471a, 471b or one of the second outer flange walls 472a, 472b of the outer flange portion 468. The first bottom lock portion 458 may be formed integrally with or otherwise attached to the exterior surface of one of the first outer flange walls 471a, 471b or one of the second outer flange walls 472a, 472b of the outer flange portion 468 of the first compartment 404. In addition, in some embodiments, the first bottom lock portion 458 may be positioned on the first compartment 404 so that the first bottom lock portion 458 aligns with the first top lock portion 448 of the outer lid 402. For example, as shown in FIGS. 7-9, the first bottom lock portion 458 may be integrally formed with and extend out from the exterior surface of the first outer flange wall 471a of the outer flange portion 468 of the first compartment 404.

The first compartment 404 may also include a second top lock portion 488 of the second locking mechanism 414. The second top lock portion 488 may extend outwards from an exterior surface of one of the first outer flange walls 471a, 471b or one of the second outer flange walls 472a, 472b of the outer flange portion 468 of the first compartment 404. The second top lock portion 488 may be formed integrally with or otherwise attached to the exterior surface of one of the first outer flange walls 471a, 471b or one of the second outer flange walls 472a, 472b of the outer flange portion 468. For example, as shown in FIGS. 9 and 12, the second top lock portion 488 may be integrally formed with and extend out from the exterior surface of the second outer flange wall 472b of the outer flange portion 468 of the first compartment 404.

In some embodiments, the second top lock portion 488 may be provided in the form of a U-shape protrusion as best shown in FIG. 14. In some embodiments, the second top lock portion 488 may be the same as or similar to the first top lock portion 448. For example, the second top lock portion 488 may include the two lock sides 450, the lock base 452 disposed between the two lock sides 450, and one or more apertures 454 in the lock base 452.

The second top lock portion 488 may be positioned on the first compartment 404 so that the second top lock portion 488 aligns or substantially aligns with a second bottom lock portion 490 disposed on the second compartment 406. In some embodiments, the second bottom lock portion 490 may have the same size, shape, and components as the second top lock portion 488. For example, as shown in FIG. 14, the second bottom lock portion 490 may be a mirror image of the second top lock portion 488 and also include two lock sides 450, lock base 452, and one or more apertures 454. Furthermore, when the first compartment 404 is closed, the one or more apertures 454 of the second top lock portion 488 may align or substantially align with the one or more apertures 454 of the second bottom lock portion 490.

As discussed above, in some embodiments, the two lock sides 450 of the second top lock portion 488 and the second bottom lock portion 490 of the second locking mechanism 414 may be parallel or substantially parallel to each other and may each have top portion 456 that has a slanted shape. The slanted shape of the top portion 456 of the lock sides 450 may facilitate the positioning of a shackle of a padlock or other attachment mechanism through the one or more apertures 454 in the lock base 452 of the second top lock portion 488 and/or the one or more apertures 454 in the lock base 452 of the second bottom lock portion 490, or vice versa, to secure the first compartment 404 to the second compartment 406.

In other embodiments, the slanted shape of the top portion 456 of the lock sides 450 may facilitate the positioning of a pen, pencil, marker, or other writing instrument through the one or more apertures 454 in the lock base 452 of the second top lock portion 448 and/or the one or more apertures 454 in the lock base 452 of the second bottom lock portion 458, and vice versa.

The second compartment 406 of the toolbox 400 may include a bottom plate 492 having a rectilinear or substantially rectilinear shape. The bottom plate 492 may include two first side panels 494a and 494b and two second side panels 496a and 496b extending upwardly from the bottom plate 492. The bottom plate 492, the two first side panels 494a, 494b, and the two second side panels 496a, 496b together may define an interior chamber 498. The interior chamber 498 may be configured to receive, store, and/or transport tools, parts, or other items.

The two first side panels 494a, 494b may have the same or substantially the same size and shape as each other and may be parallel or substantially parallel to one another. Similarly, the two second side panels 496a, 496b may have the same or substantially the same size and shape as each other and may be parallel or substantially parallel to one another. In some embodiments, each of the two first side panels 494a, 494b is longer than each of the two second side panels 496a, 496b.

In some embodiments, the first and second side panels 494, 496 may taper downward from a top edge 500 of the second compartment 406 downward to the bottom plate 492 so that a perimeter of the top edge 500 is larger than a perimeter of the bottom plate 492. In other embodiments, the first and second side panels 494, 496 may be square with the bottom plate 492 such that the perimeter of the top edge 500 is the same or substantially the same as the perimeter of the bottom plate 492.

In some embodiments, the outer rim 469 may extend around a top perimeter of the top edge 500 of the second compartment 406 opposite the bottom plate 492. The outer rim 469 may engage with the outer flange portion 468 when the first compartment 404 is closed over the second compartment 406. The compartment latch protrusion 478 may engage a bottom lip 502 of the outer rim 469 so that the first compartment 404 stays securely closed over the second compartment 406.

The second compartment 406 of the toolbox 400 may include the one or more second hinge axis members 486 of the second connection mechanism 412. The one or more second hinge axis members 486 may be the same as or similar to the first hinge axis members 444. For example, the one or more second hinge axis members 486 may include one or more attachment hubs 480 and one or more hinge rods 482 that extend through or therebetween. For example, as shown in FIGS. 7, 8, 10, 18, 22, and 23, the one or more second hinge axis members 486 may include three attachment hubs 480a, 480b, and 480c and two hinge rods 482a and 482b; the hinge rod 482a may extend between attachment hubs 480a and 480b and the hinge rod 482b may extend between attachment hubs 480b and 480c. In other instances, more or less than three attachment hubs 480 may be provided, and more or less than two hinge rods 482 may be used. For example, in some embodiments, multiple attachment hubs 480 may be provided, but only a single hinge rod 482 may be used (e.g., the single hinge rod may extend between the outer most attachment hubs and may extend through any attachment hubs placed between the outer most attachment hubs).

The one or more second hinge axis members 486 may be disposed on one of the first side panels 494a, 494b or one of the second side panels 496a, 496b. For example, as shown in FIGS. 7, 8, 10, 18, 22, and 23, the one or more second hinge axis members 486 may disposed on the second side panel 496b. In some instances, the one or more second hinge axis members 486 may be designed to enable the first compartment 404 to move (e.g., open and/or close) with respect to the second compartment 406 (e.g., the hooks 446 of the one or more second hinge attachment members 484 disposed on the first compartment 404 may movably engage with the hinge rods 482 of the one or more second hinge axis members 486).

As discussed above, the second compartment 406 may include the second bottom lock portion 490 of the second locking mechanism 414. The second bottom lock portion 490 may extend outwards from an exterior surface of one of the first side panels 494a, 494b or one of the second side panels 496a, 496b of the second compartment 406. The second bottom lock portion 490 may be formed integrally with or otherwise attached to the exterior surface of one of the first side panels 494a, 494b or one of the second side panels 496a, 496b of the second compartment 406. In addition, in some embodiments, the second bottom lock portion 490 may be positioned on the second compartment 406 so that the second bottom lock portion 490 aligns with the second top lock portion 488 of the first compartment 404. For example, as shown in FIGS. 12, 14, 17-26, 28 and 29, the second bottom lock portion 490 may be integrally formed with and extend out from the exterior surface of the second side panel 496b near the top edge 500 of the second compartment 406.

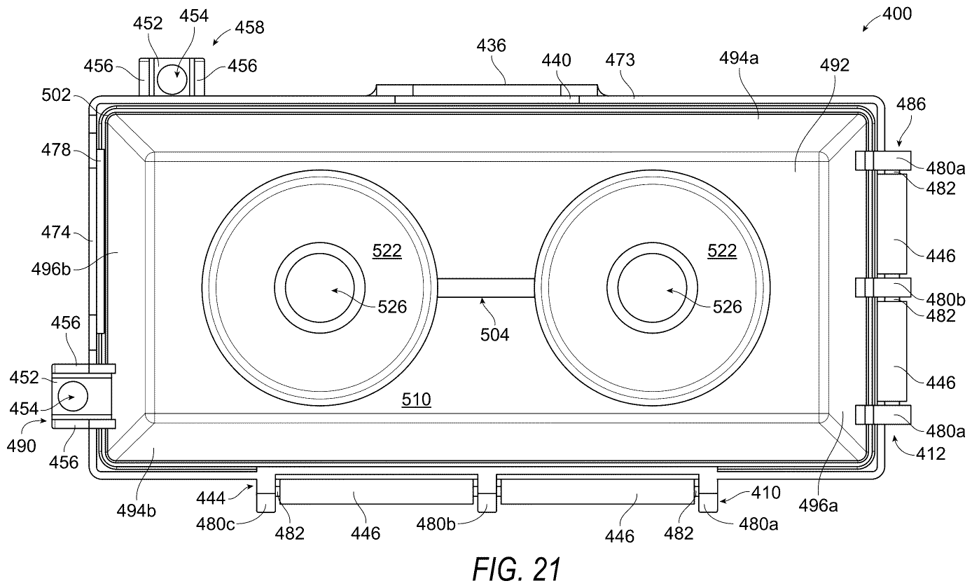

In some embodiments, the bottom plate 492 may include one or more slots 504 as shown in FIGS. 21-26. The one or more slots 504 may extend through an inner surface 508 and an outer surface 510 of the bottom plate 492 providing one or more openings therein. The one or more slots 504 may be used to attach the one or more couplings 408 to the bottom plate 492 of the second compartment 406.

In some embodiments, two slots 504 may be provided in the bottom plate 492. For example, as best shown in FIGS. 13 and 17-20, the two slots 504 may be disposed in the bottom plate 492 near or adjacent each of the second side panels 496a, 496b of the second compartment 406. In other embodiments, a single slot 504 may be provided in the bottom plate 492 as shown in FIGS. 21, 23, and 24. In some embodiments, the single slot 504 may be disposed in and extend along a center portion 506 of the bottom plate 492 providing an elongated opening therein (see FIG. 21) and may be parallel or substantially parallel to the first side panels 494a, 494b or the second side panels 496a, 496b.

The toolbox 400 may also include the one or more couplings 408 for mounting or attaching the toolbox 400 to the industrial truck 100 via the one or more slots 504. In some embodiments, the one or more couplings 408 may each include a first mounting plate 514, a second mounting plate 516, and a mounting attachment mechanism 518.

In some embodiments, the first and second mounting plates 514, 516 may each have a circular, ring, or disc shape. In other embodiments, the first and second mounting plates 514, 516 may each have a shape that is oval, rectangular, square, or any other suitable shape. In some embodiments, the first mounting plate 514 may include a top 520, a bottom 522, and one or more sides 524. In some embodiments, the first mounting plate 514 may be a magnet. In some instances, the first mounting plate 514 may be provided in the form of a ring shaped magnetic plate having a cut-out 526 disposed in a center thereof.

In some embodiments, the second mounting plate 516 may include an outer side 528, an underside 530, and a mounting through-hole 532 disposed in a center of a top side 533 of the second mounting plate 516. In some embodiments, the second mounting plate 516 may be comprised of a non-magnetic material. In other embodiments, the second mounting plate 516 may be comprised of a magnetic material. In some instances, the second mounting plate 516 may be provided in the form of an outer casing that surrounds the top 520 and one or more sides 524 of the first mounting plate 514 as best shown in FIG. 13.

In some embodiments, the first mounting plate 514 may be attached to the second mounting plate 516 via an adhesive applied to the top 520 of the first mounting plate 514 and/or the underside 530 of the second mounting plate 516. In other embodiments, the second mounting plate 516 may be comprised of a magnetic material, and the first mounting plate 514 (e.g., magnetic plate) may be magnetically connected to the second mounting plate 516. In further embodiments, the first mounting plate 514 may be attached to the second mounting plate 516 via a screw, clip, rivet, or other fastening mechanisms known in the art.

The mounting attachment mechanism 518 may include a bottom flange 534 and a threaded rod 536. In some embodiments, a rod bolt 538 may be used to attach the threaded rod 536 to the bottom flange 534. In other embodiments, the bottom flange 534 and the threaded rod 536 may be formed integrally with one another. In some embodiments, the bottom flange 534 has a circular shape and extends radially outwards from the threaded rod 536 as shown in FIG. 8. In other embodiments, the bottom flange 534 may have an oval, square, or rectangular shape, or any other suitable shape. The mounting attachment mechanism 518 may be used to attach the first and second mounting plates 514, 516 to the outer surface 510 of the bottom plate 492 of the second compartment 406. For example, as shown in FIGS. 11 and 13, the mounting attachment mechanism 518 may be positioned so that the threaded rod 536 passes through the cut-out 526 of the first mounting plate 514 and extends through the mounting through-hole 532 in the second mounting plate 516 such that the bottom flange 534 is positioned within the cut-out 526 of the first mounting plate 514 and engages with the underside 530 of the second mounting plate 516.

As best shown in FIGS. 11 and 13, the one or more couplings 408 may each be attached to the second compartment 406 of the toolbox 400 by sliding or positioning the threaded rod 536 through one of the slots 504 into the interior chamber 498 of the second compartment 406. In some embodiments, one or more washers 540 and/or one or more bolts 542 may be used to secure each of the one or more couplings 408 to the inner surface 508 of the bottom plate 492 of the second compartment 406 via the threaded rod 536.

In other embodiments, the couplings 408 may be provided in the form of one or more nuts and bolts or another attachment mechanism known in the art. The one or more bolts may extend through the one or more slots 504 in the bottom plate 492 and a portion of the industrial truck (e.g., the top 116 of the hood 110) and the one or more nuts may be used to secure the bottom plate 492 of the toolbox 400 to the industrial truck 100.

Although not shown in the figures, the toolbox 400 may also include one or more handles to enable a user or operator to easily mount the toolbox 400 on or remove the toolbox 400 from the industrial truck 100 or another surface. The handles may also enable the operator to reposition the toolbox 400 mounted on the industrial truck 100. In some embodiments, the one or more handles may be disposed on the first side panels 494 of the second compartment 406 and/or the second side panels 496 of the second compartment 406.

While not illustrated in the figures, the toolbox 400 may also include one or more exterior attachment members located on an exterior of the toolbox 400. For example, the one or more exterior attachment members may be disposed on one or more of the first side panels 494a, 494b or the second side panels 496a, 496b of the second compartment 406. The one or more exterior attachment members may be used to removably couple a cupholder, drink carrier, or other mechanism for carrying a cup, drink, or other items to the toolbox 400.

As discussed above, the toolbox 400 may include a plurality of layered components including the outer lid 402, the first compartment 404, the second compartment 406, and the one or more couplings 408. These components can be layered or arranged in a specific order to ensure the toolbox 400 can be securely closed and mounted to the industrial truck 100, 200, and/or 300.

For example, as shown in FIGS. 7-14, when in a first position, the outer lid 402 is positioned at the top of the plurality of layered components of the toolbox 400. Disposed below the outer lid 402 is the first compartment 404, followed by the second compartment 406, which is disposed below the first compartment 404. The plurality of compartments (e.g., the first compartment 404 and the second compartment 406) within the toolbox 400 are capable of mating or nesting with each other.

When in the first position, a bottom surface of the two first sides 418a, 418b and the two second sides 420a, 420b of the outer lid 402 rest on the outer flange ledge 470 of the first compartment 404. In addition, the two first sides 418a, 418b and the two second sides 420a, 420b of the outer lid 402 are designed to surround the two first walls 462a, 462b and the two second walls 464a 464b of the first compartment 404, respectively. As shown in the exploded view of FIG. 8, the two first walls 462a, 462b and the two second walls 464a 464b of the first compartment 404 are inset from the two first sides 418a, 418b and the two second sides 420a, 420b, respectively, of the outer lid 402. This allows the outer lid 402 to enclose all four walls of the first compartment 404. The outer lid 402 is able to stay positioned on the first compartment 404 via the lid latch protrusion 440 of the outer lid latch 436. The lid latch protrusion 440 extends from the inner lid latch wall 438 under the bottom flange edge 473 of the outer flange portion 468 of the first compartment 404. The lid latch protrusion 440 hooks under or forms a friction fit with the bottom flange edge 473 of the outer flange portion 468 to secure the outer lid 402 to the first compartment 404. In other embodiments, the outer lid latch 436 may attach or fasten the outer lid 402 to the first compartment 404 via other fastening mechanisms known in the art.

In the first position, the second compartment 406 is positioned under or after the first compartment 404. The outer flange portion 468 of the first compartment 404 rests on the top outer rim 469 of the second compartment 406 such that the first outer flange walls 471a, 471b and the second outer flange wall 472a, 472b surround the entire outer rim 469 of the second compartment 406. This can be seen in FIGS. 8, 11, and 13. In addition, the compartment latch 474 of the first compartment 404 extends down from the outer flange portion 468 and engages with the top outer rim 469 of the second compartment 406. More specifically, similar to the outer lid latch 436 on the outer lid 402, the compartment latch protrusion 478 of the compartment latch 474 of the first compartment 404 hooks under or forms a friction fit with the bottom lip 502 of the top outer rim 469 of the second compartment 406 to secure the outer lid 402 to the first compartment 404 when in the first position. In other embodiments, the compartment latch 474 may attach or fasten the first compartment 404 to the second compartment 406 via other fastening mechanisms known in the art.

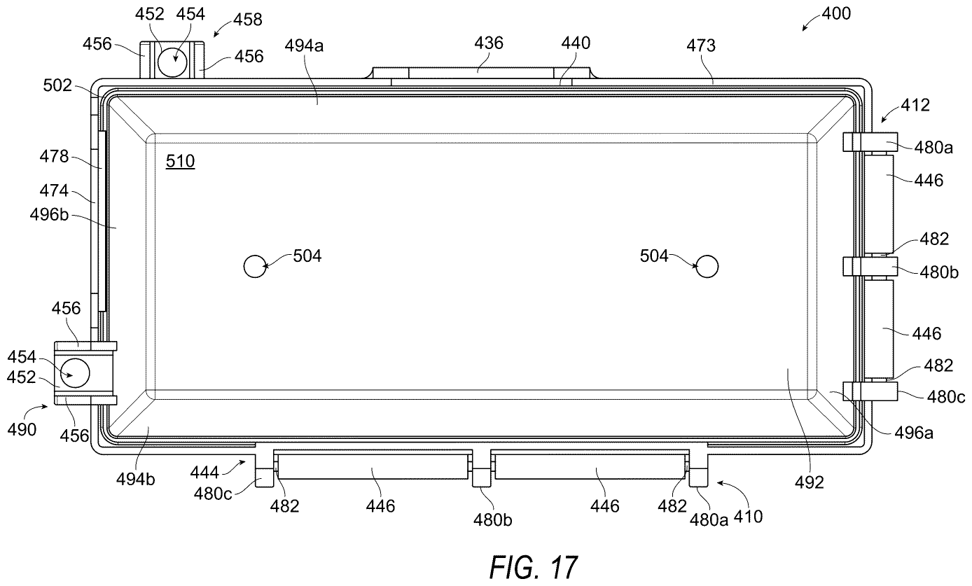

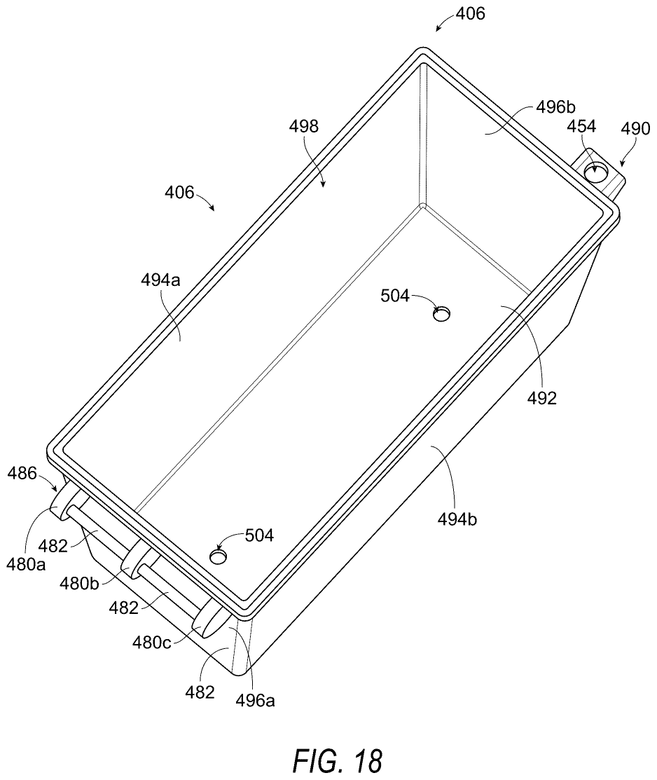

In the first position, the one or more couplings 408 of the toolbox 400 are positioned on the outer surface 510 of the bottom plate 492 of the second compartment 406. The one or more couplings 408 can be removably mounted onto the bottom plate 492 of the second compartment 406 via the mounting attachment mechanism 518 and the one or more slots 504. Thus, the user or operator has the ability to select the number of couplings 408 to use based on the type of industrial truck or other surface to which the operator would like to attach the toolbox 400. The one or more slots 504 in the bottom plate 492 of the second compartment 406 is designed to allow the use of one or more couplings 408. Further, if the user or operator does not require the use of couplings 408 for the operation of the toolbox 400, zero couplings 408 may be used (see, e.g., FIGS. 17 and 18). Since the majority of industrial trucks are constructed with metal, the one or more couplings 408 can be removably coupled in various orientations or configurations.

The positioning of the first connection mechanism 410 and the second connection mechanism 412 is important for the actuation angles of the toolbox 400. For example, the first connection mechanism 410 is located on one of the two longer sides of the toolbox 400 (e.g. the first side 418b of the outer lid 402 and the first outer flange wall 471b of the first compartment 404), and the second hinge is positioned on one of the two shorter sides of the toolbox 400 (e.g., the second outer flange wall 472a of the first compartment 404 and the second side panel 496b of the second compartment 406). The positioning of the first and second connection mechanisms 410, 412 enables both the outer lid 402 and the first compartment 404 to be opened separately or at the same time. The actuation of the first and second connection mechanisms 410 and 412 are best shown in FIGS. 25-29.

The unique positioning of the first and second connection mechanisms 410 and 412 enable the toolbox 400 to transition from the first position (e.g., the outer lid 402 and the first compartment 404 are closed) into: a) a second position, in which the outer lid 402 is opened and the first compartment 404 remains closed over the second compartment 406 (see FIGS. 25-27); b) a third position, in which the outer lid 402 is closed and the first compartment 404 is opened (see FIG. 28); and/or c) a fourth position in which the outer lid 402 and the first compartment 404 are opened (see FIG. 29). The ability to easily transition between multiple positions, enables a user or operator to easily access the first compartment 404 and/or the second compartments 406 of the toolbox 400.

Further, when the toolbox 400 is disposed on the mounting area 150a of the industrial truck 100 in the first configuration, as shown in FIGS. 1 and 2, for example, the outer lid 402 may actuate or open in a direction that is away from the operator seat 104 when the toolbox 400 is in the second position. In addition, when the toolbox 400 is in the first configuration, the first compartment 404 may actuate in a direction that is towards the rear portion 108 when the toolbox 400 moves into the third position.

When the toolbox 400 is disposed on the mounting area 150b of the industrial truck 100 in the second configuration, as shown in FIGS. 5 and 6, for example, the outer lid 402 may actuate or open in a direction that is away from the operator seat 104 when the toolbox 400 is in the second position. And, when the toolbox 400 is in the second configuration, the first compartment 404 may actuate in a direction that is away from the rear portion 108 when the toolbox 400 moves into the third position.

The toolbox 400 may further comprise additional elements that add to the functional components. The toolbox 400 may include an optional clip 415 on the outer lid 402. The toolbox 400 may also include the first and second locking mechanisms 413, 414. When in the first position, the first top lock portion 448 and the first bottom lock portion 458 of the first locking mechanism 413 align and the second top lock portion 488 and the second bottom lock portion 490 of the second locking mechanism 414 align such that the shackle portion of a lock can be placed through the one or more apertures 454 of each of the first and second locking mechanism 413, 414. Thus, when the first top lock portion 448 and the first bottom lock portion 458 of the first locking mechanism 413 receive a lock, the outer lid 402 and the first compartment 404 are securely coupled together. And, when the second top lock portion 488 and the second bottom lock portion 490 of the second locking mechanism 414 receive a lock, the first compartment 404 and the second compartment 406 are securely coupled together.

It will be appreciated by those skilled in the art that while the above disclosure has been described above in connection with particular aspects and examples, the above disclosure is not necessarily so limited, and that numerous other aspects, examples, uses, modifications and departures from the aspects, examples and uses are intended to be encompassed by the claims attached hereto. The entire disclosure of each patent and publication cited herein is incorporated by reference, as if each such patent or publication were individually incorporated by reference herein. Various features and advantages of the above disclosure are set forth in the following claims.

What is claimed is:

1. An industrial truck provided in a form of a Class I industrial truck, a Class IV industrial truck, or a Class V industrial truck comprising:
an operator cab defined by an overhead guard, the operator cab comprising:
a hood covering a power module;
an operator seat, wherein a bottom of the operator seat is coupled to a top of the hood; and
a toolbox having an outer lid with an outer lid latch, one or more hinges, a first compartment, a second compartment, and a bottom plate, wherein the bottom plate is coupled to the top of the hood adjacent to a first side of the operator seat.

2. The industrial truck of claim 1, wherein the toolbox is coupled to the top of the hood using one or more couplings removably attached to an outer surface of the bottom plate of the second compartment.

3. The industrial truck of claim 1, wherein the toolbox stays affixed to the hood when the hood is opened for access to the power module.

4. The industrial truck of claim 3, wherein the toolbox is positioned such that the toolbox fits between the operator seat and a rear portion of the overhead guard when the hood is opened for access to the power module.

5. The industrial truck of claim 1, wherein the power module is provided in the form of a traction battery.

6. The industrial truck of claim 1, wherein the power module is provided in the form of an engine connected to a fuel source.

7. The industrial truck of claim 1, further comprising:
a clip disposed on a top surface of the outer lid of the toolbox for coupling items to the outer lid.

8. The industrial truck of claim 1, wherein the toolbox is positioned so that the top surface of the outer lid of the toolbox is approximately elbow height for an operator seated in the operator seat, such that the top surface of the outer lid is a writing surface.

9. The industrial truck of claim 1, wherein the first side of the operator seat is a right side of the operator seat when an operator is seated in the operator seat.

10. The industrial truck of claim 1, wherein the outer lid of the toolbox is located above the first compartment and the second compartment and the first compartment is located in between the outer lid and the second compartment when in a first position.

11. The industrial truck of claim 10, wherein the first compartment includes a port for a charging cord and the first compartment is configured to securely transport a cell phone.

12. The industrial truck of claim 10, wherein the second compartment is configured to securely transport tools and other supplies.

13. The industrial truck of claim 1, wherein the outer lid of the toolbox is opened in a direction that is away from the operator seat, such that the outer lid latch is facing the operator seat and the one or more hinges are opposite the outer lid latch and facing an exterior of the industrial truck.

14. An industrial truck provided in a form of a Class I industrial truck, a Class IV industrial truck, or a Class V industrial truck comprising:
an operator cab defined by an overhead guard with a right rear overhead guard and a left rear overhead guard, the operator cab comprising:
a hood covering a power module;
an operator seat, wherein a bottom of the operator seat is coupled to a top of the hood; and
a toolbox comprising:
an outer lid with an outer lid latch, wherein the outer lid latch is on a first side of the toolbox, wherein the outer lid latch is positioned facing a right side of the operator seat;
one or more hinges designed to allow the toolbox to open away from the operator seat, such that the one or more hinges are on a second side of the toolbox positioned facing opposite the outer lid latch;
a first compartment positioned below the outer lid;
a second compartment positioned below the first compartment; and
a bottom plate coupled to the top of the hood adjacent to the right side of the operator seat.

15. The industrial truck of claim 14, wherein the toolbox is coupled to the top of the hood using one or more couplings removably attached to an outer surface of the bottom plate of the second compartment.

16. The industrial truck of claim 14, wherein the toolbox stays affixed to the hood when the hood is opened for access to the power module.

17. The industrial truck of claim 16, wherein the toolbox is positioned such that the toolbox fits between the operator seat and the right rear overhead guard when the hood is opened for access to the power module.

18. The industrial truck of claim 14, wherein the first compartment includes a port for a charging cord and the first compartment is configured to securely transport a cell phone.

19. The industrial truck of claim 14, wherein the second compartment is configured to securely transport tools and other supplies.

20. The industrial truck of claim 1, further comprising:
a clip disposed on a top surface of the outer lid of the toolbox for coupling items to the outer lid.
